(19) United States
(12) Patent Application Publication
(10) Pub. No.: US 2014/0190066 A1
(43) Pub. Date: Jul. 10, 2014

(54) Detachable Clamping Sinker With Water Soluble Detachment

(71) Applicant: Robert Paul Bono, Dana Point, CA (US)

(72) Inventor: Robert Paul Bono, Dana Point, CA (US)

(21) Appl. No.: 14/156,109

(22) Filed: Jan. 15, 2014

Related U.S. Application Data
(63) Continuation-in-part of application No. 13/587,668, filed on Aug. 16, 2012, now abandoned.
Application No. 13/587,668 is a continuation of application No. 12/269,641, filed on Nov. 12, 2008, now Pat. No. 8,261,484.
(60) Provisional application No. 60/990,860, filed on Nov. 28, 2007.

(51) Int. Cl. A01K 95/02

(52) U.S. Cl. CPC A01K 95/02
USPC 43/43.12

(57) ABSTRACT

A detachable clamping sinker automatically detaches from fishing line after immersion in water. The sinker includes a first weighted half, and a second weighted half that is moveable relative to the first weighted half. An elastic tie assembly couples the first weighted half to the second weighted half. The elastic tie assembly includes an elastic member, and an externally exposed rapidly disintegrating water soluble material linking the elastic member to one of the weighted halves. The elastic member under tension imparts a force holding the first weighted half against the second weighted half to clamp a fishing line therebetween. The disintegrating material when dry withstands a casting load and when wet rapidly dissolves to release the tension that clamps the fishing line. The weighted halves may be biodegradable or dissolvable.

This application is a continuation-in-part of U.S. patent application Ser. No. 13/587,668 filed on Aug. 16, 2012, which is a continuation of U.S. patent application Ser. No. 12/269,641 filed on Nov. 12, 2008, all of which are fully incorporated herein by reference.

### BACKGROUND OF THE INVENTION

1. Field of the Invention

The present invention relates generally to detachable sinkers for use with fishing line. More specifically, the invention relates to a sinker affixed with a rapidly disintegrating water soluble material that allows the sinker to detach from the fishing line.

2. Description of Related Art

The distance that a fisherman can achieve when casting line is conventionally increased by adding weight to the baited end of the line. This weight, commonly called a sinker, may be composed of any dense material, such as lead, and may be attached to the line in any of various ways. One way is by tying the sinker to the baited end using a separate leader. Another way is by attaching the sinker directly to the main line some distance behind the bait, for example, by threading the main line through a loop in the sinker and tying it off, or by compressing a specially formed sinker (known as split shot) directly onto the line. Another way to add weight to the baited end is by forming a fishing lure with integral weight, as is commonly done for spoons, spinners, and other fishing devices designed for deep water or bottom fishing.

While the added weight may improve casting distance, problems may arise after the bait hits the water. One problem is that the weight drags the bait to the bottom. This may not be desirable for certain techniques such as fly fishing, which are used to catch fish that feed near the surface. Another problem is that the weight can interfere with the action of a lure, or cause the line to become tangled during retrieval. Another problem is that dragging too much weight through the water can frighten the fish or otherwise discourage them from biting. But perhaps the biggest problem with loading up on weight is that it greatly increases the chance of snagging the line on the bottom during retrieval. This leaves the fisherman with the frustrating chore of having to cut the line and rig up a new baiting system, not to mention the loss of another hook, line, and sinker.

Fishing and the capture of fish and other water dwelling wildlife would be greatly improved by a sinker that can be added to the baited end of a fishing line and jettisoned after casting.

### SUMMARY OF THE INVENTION

The present invention provides a detachable sinker that automatically detaches from fishing line after immersion in water. A detachable sinker according to the invention includes a weight attachable to a fishing line, and a rapidly disintegrating water soluble material connected to the weight for attaching the weight to the fishing line. In one embodiment, the rapidly disintegrating water soluble material comprises a dissolvable product that when dry, possesses sufficient tensile strength to withstand the load of the weight during casting, and when wet, rapidly dissolves to release the weight from the fishing line. The detachable sinker may include a fastening component acting as a strengthening interface between the rapidly disintegrating water soluble material and the fishing line, and may further include a wildlife attractant that is suspended by, held by or held within the rapidly disintegrating water soluble material or a non-disintegrating material. The wildlife attractant may dissolve after immersion and after being rapidly released from the fishing line by the disintegrating material and thus diffuse throughout the water to attract fish to the casting site. In another embodiment, some or all of the wildlife attractant may be left affixed to the line by the non-disintegrating material.

Many embodiments of the invention are presented. The rapidly disintegrating water soluble material may form a loop for attaching the weight to the fishing line. The loop may pass through a hole formed in the weight, or it may wrap one or more times around the weight. The fastening component may join ends of the rapidly disintegrating water soluble material into the loop. The detachable sinker may further include an attachment means for coupling the rapidly disintegrating water soluble material to the fishing line. The attachment means may further include an elongated clamp of compressible material, where the clamp has sufficient length to compress both the fishing line and a length of the rapidly disintegrating water soluble material. Alternatively, the attachment means may include a portion of the rapidly disintegrating water soluble material combined with a mass of moldable adhesive, or the attachment means may include a perforated sinker attachment for threading the rapidly disintegrating water soluble material therethrough.

In another embodiment, the weight of the sinker may be a dissolvable weight. The dissolvable weight may be formed or molded from a melange of wet and dry ingredients, and the rapidly disintegrating water soluble material may be connected to the weight by partially sinking it into the melange prior to curing the weight. The dissolvable weight may include a wildlife attractant as an ingredient.

In another embodiment, a detachable sinker according to the invention may include indicia indicating a weight value, a release time, or a depth rating for the rapidly disintegrating water soluble material. The release time or depth rating may indicate the approximate time or depth at which the rapidly disintegrating water soluble material releases the weight from the fishing line, and if so equipped, releases the wildlife attractant into the water.

In another embodiment, a detachable sinker according to the invention includes a plurality of circular weights concentrically arranged, each weight having a center hole, a clamping means disposed through the center holes, and a rapidly disintegrating water soluble tab clamped between the circular weights by the clamping means, the tab defining a hole on an unclamped portion of the tab for attaching the weights to the fishing line.

In another embodiment, a detachable sinker according to the invention includes a sack of rapidly disintegrating water soluble material, weight loaded within the sack, and an attachment means for coupling the sack to the fishing line. A wildlife attractant may be contained within the sack.

In another embodiment, the invention provides a sinker assembly that includes a detachable sinker, a fixed sinker, and an attachment means having a first portion for attaching the assembly to a fishing line, a second portion for attaching the detachable sinker to the assembly, and a third portion for attaching the fixed sinker to the assembly. One or both of the detachable sinker and the fixed sinker may be dissolvable weights and may include a wildlife attractant.

Additional embodiments describe a detachable clamping sinker, which includes a first weighted half, a second weighted half moveable with respect to the first weighted half, and an elastic tie assembly that couples the first weighted half to the second weighted half. The elastic tie assembly includes an elastic member and an externally exposed rapidly disintegrating water soluble material linking the elastic member to one of the weighted halves. The elastic member imparts a force holding the first weighted half against the second weighted half to clamp a fishing line therebetween. The externally exposed rapidly disintegrating water soluble material when dry withstands a casting load and when wet rapidly dissolves to release the tension that clamps the fishing line.

Detachable clamping sinkers according to the invention may be configured to allow the first weighted half and the second weighted half to be separated by hand, either by sliding or rotating one half relative to the other, by increasing tension on the elastic member to facilitate release of the fishing line. The detachable clamping sinkers described herein may also comprise various fishing line locking means, such as cooperatively engaging angled edges formed in the weighted halves, or one or more complimentary pairs of protrusions and recesses formed in cooperatively engaging jaws. One or both of the weighted halves may be offset or define channels to externally expose the rapidly disintegrating water soluble material. In addition, the weighted halves may be configured with slot and rail systems to limit transverse or longitudinal displacement of one half with respect to the other.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals designate like parts throughout the different views, wherein:

FIG. 1 is a perspective view of one embodiment of a detachable sinker according to the invention held by a rapidly disintegrating water soluble tab.

FIG. 2 is a perspective view of one embodiment of a detachable sinker according to the invention having a cylindrical weight held by a rapidly disintegrating water soluble ring.

FIG. 3 is a perspective view of another embodiment of a detachable sinker according to the invention having a rapidly disintegrating water soluble bag for holding weight.

FIG. 4 is a perspective view of another embodiment of a detachable sinker according to the invention having a bar weight wrapped by a rapidly disintegrating water soluble strip.

FIG. 5 is a perspective view of an embodiment of a detachable sinker according to the invention having a rectangular weight wrapped by an adhesive strip of rapidly disintegrating water soluble material.

FIG. 6 is a perspective view of an embodiment of a detachable sinker according to the invention having a rapidly disintegrating water soluble bag enclosed by a staple with eyelet.

FIG. 7 is a perspective view of another embodiment of a detachable sinker according to the invention having a rapidly disintegrating water soluble ring passing through a hole formed in a rectangular weight.

FIG. 8 is a perspective view of an embodiment of a detachable sinker according to the invention having a rapidly disintegrating water soluble tab clamped between rounded, riveted weights.

FIG. 9 is a perspective view of another embodiment of a detachable sinker according to the invention having a rapidly disintegrating water soluble tab clamped to a rectangular weight.

FIG. 10 is a perspective view of an embodiment of a detachable sinker according to the invention having a rapidly disintegrating water soluble bag affixed with a wildlife attractant.

FIG. 11 is a perspective view of an embodiment of a detachable sinker according to the invention having a rapidly disintegrating water soluble tab fixed to a dissolvable wildlife attractant that acts as a weight.

FIG. 12 is a perspective view of another embodiment of a detachable sinker according to the invention having a rapidly disintegrating water soluble tab fixed to a dissolvable wildlife attractant that acts as a weight.

FIG. 13 shows rear (A), side (B), top (C), and front (D) views of a means according to the invention for attaching a detachable sinker according to the invention to a length of fishing line.

FIG. 14 shows rear (A), side (B), top (C), and front (D) views of another means according to the invention for attaching a detachable sinker according to the invention to a length of fishing line.

FIG. 15 shows rear (A), side (B), top (C), and front (D) views of a removable means according to the invention for attaching a detachable sinker according to the invention to a length of fishing line.

FIG. 16 is a side view of another removable means according to the invention for attaching a detachable sinker according to the invention to a length of fishing line.

FIG. 17 is a top view of the removable attaching means of FIG. 16.

FIG. 18 is an end view of the removable attaching means of FIG. 16.

FIG. 19 is an illustration of the removable attaching means of FIG. 16 attaching a detachable sinker according to the invention to a length of fishing line.

FIG. 20 is an illustration of the removable attaching means of FIG. 15 attaching a detachable sinker according to the invention to a length of fishing line.

FIG. 21 is a perspective view of another removable means according to the invention for attaching a detachable sinker according to the invention to a length of fishing line.

FIG. 22 is an illustration of the removable attaching means of FIG. 21 attaching a detachable sinker according to the invention to a length of fishing line.

FIG. 23 is a conceptual drawing of another removable means according to the invention for attaching a detachable sinker according to the invention to a length of fishing line.

FIG. 24 is a side view of another embodiment of a detachable sinker according to the invention having a rapidly disintegrating water soluble loop fixed to a dissolvable weight containing a wildlife attractant.

FIG. 25 is an illustration of the removable attaching means of FIG. 23 in an open position attaching the detachable sinker of FIG. 24 to a length of fishing line.

FIG. 26 is an illustration of the removable attaching means of FIG. 23 in a closed position attaching the detachable sinker of FIG. 24 to a length of fishing line.

FIG. 27 is a top view of another removable means according to the invention, shown in an open position, for attaching a detachable sinker according to the invention to a length of fishing line.

FIG. 28 is a top view of the removable attaching means of FIG. 27, shown in a closed position, for attaching a detachable sinker according to the invention to a length of fishing line.

FIG. 29 is a side view of the removable attaching means of FIG. 27.

FIG. 30 is an illustration of the removable attaching means of FIG. 27 in a closed position attaching the detachable sinker of FIG. 24 to a length of fishing line.

FIG. 31 shows rear (A), side (B), top (C), and front (D) views of one embodiment of a means according to the invention for attaching both a detachable weight and a fixed weight to a length of fishing line.

FIG. 32 shows a top view of the attachment means of FIG. 31 with the fixed weight attached.

FIG. 33 shows a top view of an embodiment of a sinker assembly according to the invention that includes an attachment means, a detachable weight, and a fixed weight, each weight either non-dissolvable or dissolvable and capable of incorporating a wildlife attractant.

FIG. 34 shows a top view of an embodiment of a detachable sinker according to the invention having a flap of rapidly disintegrating water soluble material and a mass of moldable adhesive serving as a means (shown in an open position) for attaching the sinker to fishing line.

FIG. 35 shows a top view of the embodiment of FIG. 34 with the attachment means shown in a closed position.

FIG. 36 shows a side view of the embodiment of FIG. 34.

FIG. 37 shows a front view of an embodiment of a detachable clamping sinker according to the invention.

FIG. 38 shows a side view of the sinker of FIG. 37.

FIG. 39 shows a cutaway side view of the sinker of FIG. 37.

FIG. 40 shows a rear view of a clamping arm of the sinker of FIG. 37.

FIG. 41 shows a magnified side view of one embodiment of an elastic member that provides a clamping force for the sinker of FIG. 37.

FIG. 42 shows a magnified side view of another embodiment of an elastic member that provides a clamping force for the sinker of FIG. 37.

FIG. 43 shows a side view of another embodiment according to the invention of a detachable clamping sinker having cooperating receiving and plugging halves.

FIG. 44 shows a front view of the sinker of FIG. 43.

FIG. 45 shows a front view of another embodiment according to the invention of a detachable clamping sinker having cooperating receiving and plugging halves.

FIG. 46 shows an outer side view of the sinker of FIG. 45.

FIG. 47 shows an interfacing side view of a receiving half of the sinker of FIG. 45.

FIG. 48 shows an interfacing side view of a plugging half of the sinker of FIG. 45.

FIG. 49 shows a side view of another embodiment according to the invention of a detachable clamping sinker having cooperating receiving and plugging halves.

FIG. 50 shows a front view of the sinker of FIG. 49.

FIG. 51 is a perspective view of another embodiment according to the invention of a detachable clamping sinker having cooperating stationary and rotating halves.

FIG. 52 is a lower perspective view of the sinker of FIG. 51.

FIG. 53 is a frontal view of the sinker of FIG. 51.

FIG. 54 is a perspective view of a stationary half of the sinker of FIG. 51.

FIG. 55 is a perspective view of a rotating half of the sinker of FIG. 51.

FIG. 56 is a perspective view of another embodiment according to the invention of a detachable clamping sinker having cooperating stationary and sliding halves.

FIG. 57 is a lower perspective view of the sinker of FIG. 56.

FIG. 58 is a frontal view of the sinker of FIG. 56.

FIG. 59 is a frontal perspective view of the stationary half of the sinker of FIG. 56.

FIG. 60 is a lower perspective view of the sliding half of the sinker of FIG. 56.

FIG. 61 is a perspective drawing that illustrates one embodiment of an elastic tie assembly for use with a sinker according to the invention.

FIG. 62 is a perspective drawing that illustrates another embodiment of an elastic tie assembly for use with a sinker according to the invention.

FIG. 63 is a perspective view of another embodiment of a detachable clamping sinker according to the invention.

FIG. 64 is a top view of the sinker of FIG. 64.

FIG. 65 is a bottom view of the sinker of FIG. 64.

FIG. 66 is an end view of the sinker of FIG. 64.

FIG. 67 is a side view of the sinker of FIG. 64, shown in an open position.

FIG. 68 is a top view of the sinker of FIG. 64, shown in an open position.

FIG. 69 is a top perspective view of the stationary half of the sinker of FIG. 64.

FIG. 70 is a lower perspective view of the sliding half of the sinker of FIG. 64.

### DETAILED DESCRIPTION OF THE INVENTION

The following disclosure presents various exemplary embodiments of the invention for providing a detachable sinker with a rapidly disintegrating water soluble material used to effect attachment. The sinker allows a fisherman to benefit from additional weight to achieve superior distance when casting, and improves the precision of bait delivery without burdening the fisherman with the additional weight dragging on the line during retrieval. The invention also improves the presentation of bait after entering the water and during retrieval, and can leave a trail of wildlife attractant in the wake of fishing line being retrieved, or can leave a patch of wildlife attractant resting on the bottom near the fisherman's casting area.

FIG. 1 illustrates one embodiment of a detachable sinker 10 according to the invention. Sinker 10 includes a volume or mass of material 11 acting as a weight, and a rapidly disintegrating water soluble material 13 for attaching the weight to a fishing line. Sinker 10 may also include a fastening component 15 that acts as a strengthening interface between the fishing line and the rapidly disintegrating water soluble material 13.

Weight 11 may be any material of sufficient density to assist a fisherman in casting out the fishing line. Weight 11 may be formed as a single mass, or may be a group of smaller masses collected together. Examples of material that may compose weight 11 include any one or any combination of the following: iron, steel, cast iron, lead, stone, concrete, ceramic, or other dense metals or refractory type materials. These materials are offered as examples only, and not by way of limitation. In a preferred embodiment, steel is used as the material of choice for a number of reasons, including cost, ease of fabrication, dissolution in water by rusting, and environmental compatibility.

Rapidly disintegrating water soluble material 13 may be composed of any material that when dry, possesses sufficient tensile strength to withstand the load of weight 11 during casting, and when wet, can rapidly release weight 11 from the fishing line shortly after contacting water. In one embodiment, sinker 10 may have a ten-second release time, which means that at ten seconds (plus or minus some tolerance) after immersion in water, material 13 dissolves such that it loses its tensile properties. Loss of tensile properties means that an amount of material 13 (such as a ½ inch wide strip) used on sinker 10 for retaining a specific weight 11 (e.g. one-ounce) is no longer able to support the specific weight against the pull of gravity under water. In another embodiment, a sinker 10 may have a one-second release time, meaning that an amount of material 13 used on sinker 10 loses its ability to support a specific weight against the pull of gravity under water in about one second. Release times other than one and ten seconds are possible within the scope of the invention. Examples of tolerances are tolerances on the order of 5 seconds, or 1 second, or a fraction of a second.

The release time of a sinker according to the invention is a predetermined value that may be determined, for example, based on empirical data and experimentation. The predetermined release time may indicate an approximate time lapse after the sinker is immersed in water after which the rapidly disintegrating water soluble material dissolves sufficiently to release the weight from the fishing line or to allow the weight to detach therefrom. The release time of the sinker may also be expressed in terms of a range, i.e. a time period. For example, the time period may have a duration anywhere between about one second and about 120 seconds.

According to the invention, release time may also be expressed in terms of water depth. That is, a sinker may have a depth rating that indicates an approximate depth at which the rapidly disintegrating water soluble material dissolves in water sufficiently to release the weight from the fishing line after the sinker sinks from a surface of the water by force of gravity. In one embodiment, the detachable sinker may have a depth rating of about one foot. In another embodiment, the detachable sinker may have a depth rating expressed in terms of a range, where the range may lie anywhere between about one foot and about 1000 feet. Also, the detachable sinker may have more than one release time or depth rating. For example, the sinker may have a first rating for use in fresh water, and a second rating for use in salt water.

A sinker according to the invention, or any embodiment of such a sinker herein disclosed, may include readable indicia printed, stamped, molded or otherwise formed on the sinker that corresponds to a weight value, a release time value, a release time range, a depth rating, or a depth range. The indicia may also include multiple indices corresponding to both salt water and fresh water ratings for depth or release time.

In one embodiment, material 13 may be composed of a paper-like material such as Dissolvo®. Other paper and paper-like products are also suitable for this purpose, such as materials used to temporarily block or dam pipes, and materials used in the formation of packaging labels that very easily dissolve in water. Material 13 may be formed as a bag, a strap, or another configuration suitable for attaching to or containing weight 11. Material 13 may be folded any number of times to achieve a desired tensile strength, or a desired release time. By making slight adjustments in the number of folds, or in the formulation or configuration of material 13, a sinker according to the invention can be adjusted to descend to a specific depth, or to a depth range, before releasing the attached fishing device or bait to assume its natural buoyancy and underwater mobility. Different depth ratings may be advantageous for certain types of fishing or in presenting certain types of bait.

Fastening component 15 may be provided to facilitate attachment of weight 11 to material 13. In one embodiment, fastening component 15 may be a ring or grommet, made of metal, paper, plastic, or rubber material. Preferably, fastening component 15 is composed of a biodegradable material. Fastening component 10 may also be formed from the same material as material 13, with a greater thickness or density to improve the strength of attachment.

As shown in FIG. 1, weight 11 may define a hole or slot 17 formed through its mass. Rapidly disintegrating water soluble material 13 may be formed into a foldable or bendable strip, and passed through hole 17. Doubling the strip of material 13 in this fashion provides for greater tensile strength. The ends 14 of material 13 may then be joined together using component 15 and coupled to weight 11 as shown. The ends 14 may be attached together by gluing, stapling or other fastening or adhesive means. Alternatively, fastening component 15 may also function as the fastening means to connect ends 14. Weight 11 may then be attached to a fishing line by threading the line through fastening component 15 and tying it off, for example, using a fisherman's knot.

In operation, within a few seconds or less after immersing sinker 10 in water, material 13 disintegrates, thereby releasing weight 11 from the fishing line. Individual components of sinker 10 would then deteriorate in the water in an environmentally friendly manner. A weight 11 made from iron would eventually rust away and release environmentally harmless iron oxide into the water. Rapidly disintegrating water soluble material 13 would quickly dissolve and release into the water its environmentally harmless constituents such as cellulose, silica, and paper fiber. Fastening component 15 would either dissolve, or be drawn out of the water with the fishing line, depending on the hydrophilic properties of its material.

In one exemplary embodiment, length A may be about 1 inch, width B may be about ¾ inches, and thickness C may be between about ¼ and about ⅜ inches. When sinker 10 is formed from steel, these dimensions produce a weight 11 weighing about one ounce. The dimensions may be scaled, as necessary, to achieve a desired weight.

Many other embodiments of a sinker according to the invention are possible. In each of the following embodiments, the materials of construction of the various components may be similar to materials disclosed in the embodiment of FIG. 1.

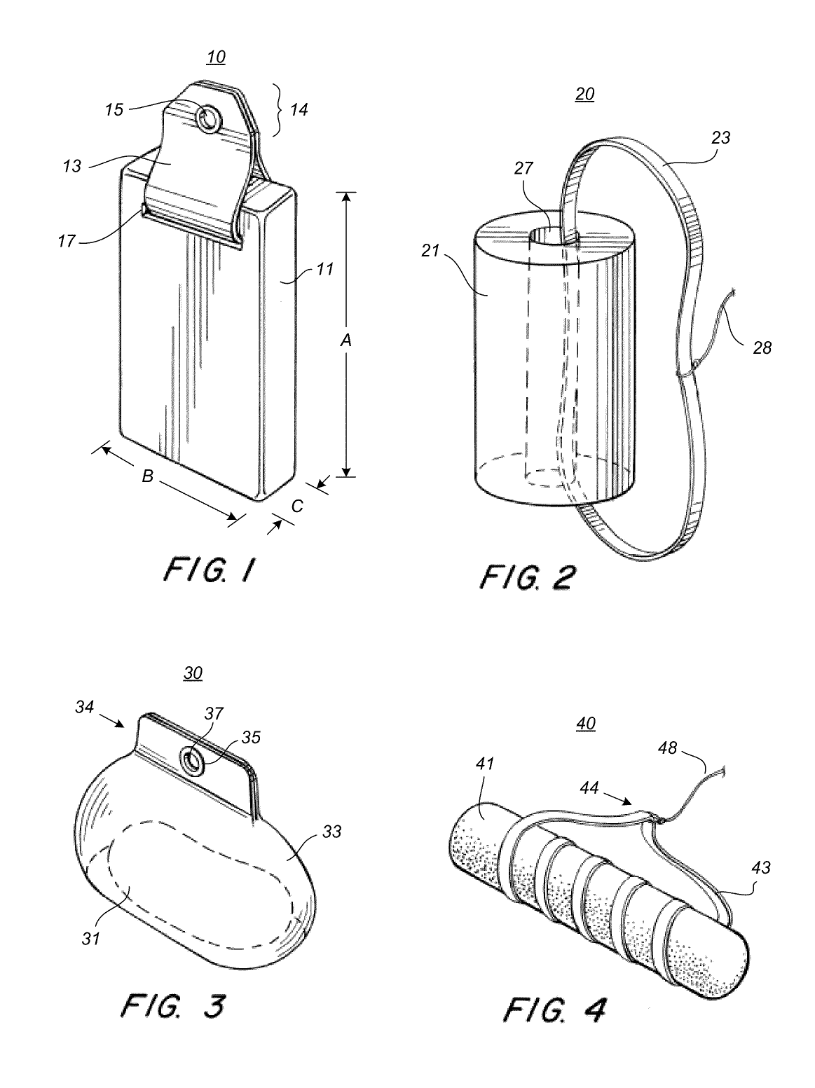

FIG. 2 shows another embodiment of a sinker according to the invention. Sinker 20 includes a cylindrical weight 21, which has a hole 27 drilled through its center along a longitudinal axis, as shown. Rapidly disintegrating water soluble material 23 may be formed into one or more loops that pass through hole 27. A fishing line 28 may be attached directly to material 23. This embodiment does not use a separate fastening component. Weight 21 may be conveniently cut from metal pipe stock at any of various lengths to achieve a desired weight. Weight 21 may also be cut from bar stock and drilled to form hole 27.

FIG. 3 illustrates another embodiment of a sinker according to the invention. In this embodiment, sinker 30 may generally resemble a tea bag. A weight or group of weights 31 may be contained within a bag 33 that is formed from a rapidly disintegrating water soluble material. Bag 33 may be enclosed at one end 34 by stapling, grommeting, adhesive, or other means. A hole 37 may be formed in the closed end 34 for threading of fishing line. A grommet 35 may be used to strengthen hole 37 or securely close the end 34. In sinker 30, different weights for weight 31 may be achieved by loading different amounts of small weights (such as metal shot) into bag 33 prior to closing the bag.

FIG. 4 illustrates another embodiment of a sinker according to the invention. In this embodiment, sinker 40 may be formed from a bar weight 41 that may be generally cylindrical or rectangular and wrapped one or more times with a continuous strip 43 of rapidly disintegrating water soluble material. The ends of strip 43 may be joined together at a location 44, thereby forming a loop through which a fishing line 48 may be threaded and attached, as shown. Weight 41 may be conveniently cut from metal rod or bar stock at any of various lengths to achieve a desired weight.

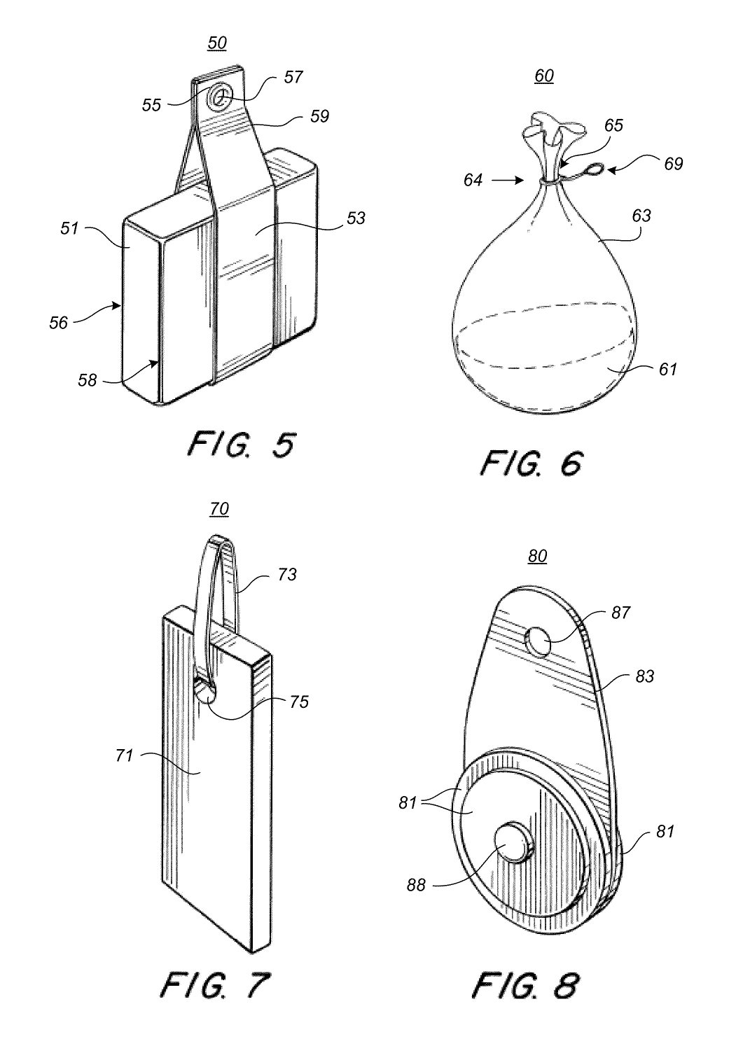

FIG. 5 shows another embodiment of a sinker according to the invention. Here, sinker 50 includes a generally rectangular weight 51 and a strip 53 of rapidly disintegrating water soluble material. Strip 53 may be glued or pinned to weight 51 along opposing sides 56 and 58 of weight 51. In one embodiment, strip 53 may be an adhesive strip. Tabs 59 may be formed at the ends of strip 53 and attached together above the top of weight 51 by stapling or gluing or grommeting. A perforation or hole 57 may be formed in tabs 59, through which fishing line may be threaded and tied off. A grommet 55 may be used to reinforce the hole 57, and to join together two ends of strip 53.

FIG. 6 shows another embodiment of a sinker according to the invention that may resemble a small bag. Sinker 60 may include a weight or group of small weights 61 that are enclosed within a sack 63 formed from rapidly disintegrating water soluble material. The top 64 of sack 63 may be pinched together to enclose its contents. A staple 65 having an eyelet 69 may be affixed to the top 64. The staple 65 pinches the top 64 of sack 63 to keep the sack closed and to prevent weight 61 from falling out. Eyelet 69 provides a convenient location for attaching a fishing line to the sinker.

FIG. 7 shows another embodiment of a sinker according to the invention designed for ease of manufacture. Sinker 70 may consist of only two pieces: a weight 71 and a loop 73 of rapidly disintegrating water soluble material. Weight 71 may be formed from rectangular bar stock to any desired length, and may include a hole 75 formed through weight 71, for example, by stamping, punching, or drilling. To form loop 73, the rapidly disintegrating water soluble material may be formed first as a strip, one end of which may then be passed through hole 75, and then joined to an opposite end by stapling, compression, glue, or other adhesive to complete the loop. A fishing line may then be tied to loop 73.

FIG. 8 shows an embodiment of a sinker according to the invention designed for ease of manufacture using weight materials that may be obtained off the shelf from a hardware store. Sinker 80 includes a plurality of circular weights 81 and rapidly disintegrating water soluble tab 83 that is clamped between the weights. Weights 82 may be flat washers made of carbon steel, plated steel, or another metal, metal alloy, or dense material. These weights or washers may be stacked to achieve a desired total weight for the sinker. Flat washers are a preferred material in this embodiment for many reasons. Flat washers are available in a wide selection of weights and sizes, and may be easily combined and joined together. In addition, the center hole of each flat washer provides a means for attaching at least one washer on either side of tab 83, and clamping tab 83 between the washers, as shown. Clamping the tab in this manner may be achieved using fasteners such as a bolt and nut, or by using a pin or rivet 88. In this configuration, tab 83 must allow the bolt, pin, or rivet 88 to pass through the center holes of the flat washers to properly clamp the tab securely in place. This may be achieved by inserting tab 83 only part way between the washers so that no part of the tab interferes with the center holes, or tab 83 may be shaped to allow passage of rivet 88, for example, by forming an open area or hole (not shown) in tab 83 that may be aligned with the center holes of washers 81. Tab 83 may also include an eyelet or hole 87 on an unclamped portion of the tab for attaching sinker 80 to a fishing line.

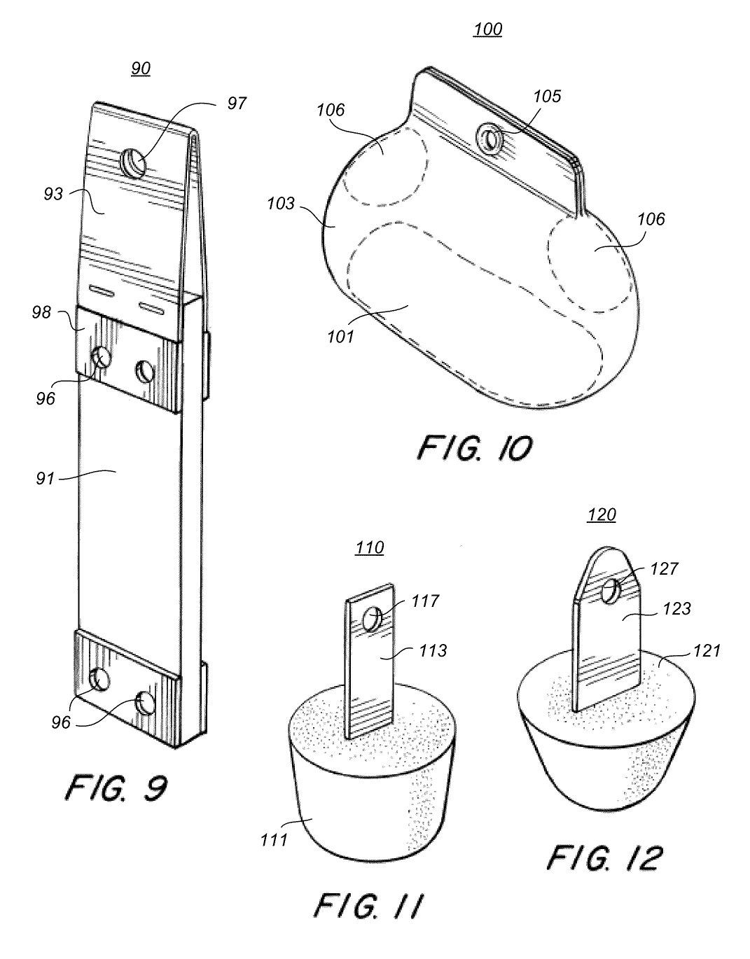

FIG. 9 shows an embodiment of a sinker according to the invention capable of providing heavier weights than some of the sinkers previously described. Sinker 90 may be formed from a rectangular weight 91, one or more clamping brackets 98, and a rapidly disintegrating water soluble tab 93 clamped between weight 91 and brackets 98. Holes 96 may be formed in brackets 98 and aligned with cooperating holes or studs formed in weight 91 to provide a means for clamping weight 91 and tab 93 between clamping brackets 98, using fastening hardware or equivalent. Preferably, tab 93 is folded in half so that it may be clamped to weight 91 at both the front and rear sides of the weight, as shown. This provides about twice as much clamping area across the tab as may be provided, for example, in the embodiment of sinker 80. And, as in the embodiments of sinkers 10 and 50, doubling the tab of rapidly disintegrating water soluble material provides greater tensile strength. The additional clamping area combined with the double tab allows the tab to suspend a greater amount of weight for the sinker. A hole 97 may be formed through both halves of the doubled tab 93, as shown, for attaching a fishing line or leader.

In any of the foregoing embodiments, a sinker according to the invention may be scaled up or down, depending on the application. For example, the embodiments of sinkers 10, 20, 40, 50, 70, and 90 may be most suitable for scaling up for lake or deep-sea fishing, while the embodiments of sinkers 30, 60, and 80 may be most easily miniaturized for pond, stream, or fly fishing. In the latter case, the sinker may be attached to a lure or fly by impaling the bag or sack portion of the sinker directly onto the fish hook.

FIG. 10 shows an embodiment of a sinker according to the invention that includes an additional component for attracting fish or other wildlife. A bag-type sinker 100 may be generally similar to sinker 30, and may include a weight 101 enclosed within a bag 103 made from a rapidly disintegrating water soluble material. An optional fastening component 105 (such as a grommet) may be attached a closed end of the bag 103 as in embodiments previously described. A scent or attractant 106 may be collected in a dense, concentrated form and suspended on, attached to, or held within the rapidly disintegrating water soluble bag 103. Scent 106 may be any natural or artificial wildlife attractant or scent, such as fish attractant manufactured by Scientific Bass Products, Inc.

Upon immersion of bag 103 into water, the bag rapidly dissolves, releasing both the weight 101 and the scent 106. In another embodiment, the scent may be commingled with the weight, for example, by mixing metal particles or metal shot into the scent material. The mixture may then be attached to, suspended on, or contained within a rapidly disintegrating water soluble material. In any embodiment using the attractant, the sinker may be configured to release the mixture at a certain release time or depth.

FIGS. 11 and 12 illustrate exemplary embodiments of sinkers according to the invention that incorporate dissolvable weights. The dissolvable weights may be composed at least partially from fish attractant. The embodiments 110 and 120 vary in terms of size and shape, but for the most part function identically. Variations in size and shape will, to some degree, affect on the dynamics of the sinker during both casting and sinking. But because the sinker weights are molded, many different aesthetic or ornamental designs are possible. For example, a sinker weight according to the invention may be molded into the shape a bomb, a grenade, a fruit, a fish, a lobster, a bird, or any other animal, object, or symbol.

Each of these sinkers may include two main parts: a dissolvable weight 111 or 121, and a rapidly disintegrating water soluble tab 113 or 123. The dissolvable weight 111 or 121 may be formed from a mixture of wet and dry ingredients and molded into a desired size and shape. Prior to drying or curing, the tab 113 or 123 may be partially inserted within, or sunk into the mixture. Alternatively, the tab may be placed into a mold and the mixture may then be poured or collected around the tab. Once the dissolvable weight is sufficiently cured, the tab becomes cemented in place to provide a means for attaching the weight to a fishing line. A hole 117 or 127 may be formed near one end of the tab for this purpose. The opposite end of the tab (not shown) may be bent an angle or divided into multiple segments to improve its strength of connection within the cured weight.

A mixture suitable for use in creating a dissolvable weight according to the invention may be a melange of base ingredients such as water, acids, bases, salts, oils, emulsifiers, plasticizers, thickeners, and additives such as scents, colorings, and organic bait or fish foods. When freshly mixed, the melange should have a thick, moldable consistency, like a damp mixture of grout or plaster. When dry and cured, the mixture forms a densely packed, cohesive but somewhat crumbly solid. When the cured mixture is immersed in water, it dissolves partly or completely and effervesces, releasing the additives to diffuse throughout the water.

One example of a dissolvable weight mixture according to the invention may be formed from the following dry and wet ingredients and in the stated general proportions:

Dry Ingredients: 1 cup baking soda, ½ cup citric acid, ½ cup corn starch, ⅓ cup sea salt, 1 tablespoon shrimp meal.

Wet Ingredients: 1½ tablespoons vegetable oil, 1 tablespoon fish oil, ¾ tablespoons water, ¼ teaspoon borax, 1 to 2 drops of red food color.

To properly form the melange, the first three dry ingredients may be sieved to achieve a smooth, homogeneous blend. The salt and shrimp meal may then be added to the other dry ingredients and thoroughly mixed in. The wet ingredients may be combined in a separate container and mixed or shaken vigorously for about half a minute. The wet ingredients may then be gradually added to the dry ingredients while continuously mixing the two together to inhibit chemical reactions. When the wet and dry ingredients form a homogeneous mass, the mixture is ready to be poured or pressed into a mold to form a dissolvable weight. The rapidly disintegrating water soluble material should be placed into the mold at this time. The molded weight may then be left to cure, for example, by slowly drying in ambient conditions for a period between about two and about ten days, or by baking for a period of between about two and about six hours at temperature between about 150 and about 200 degrees F.

The above recipe is presented as an example only, and does not limit the invention in any way. Generally, the melange should contain a base and an acid in a proportion that produces a fizzing effect that forcibly distributes the additives throughout the water. For example, a dissolvable weight composed primarily of a base such as baking soda or other soluble carbonate, sesquicarbonate, or bicarbonate, and an acid such as citric acid or other organic acid, will upon immersion react with water and dissolve, producing carbon dioxide gas and releasing its interior contents. In a baking soda and citric acid mixture, the ratio of soda to acid should be kept at around 2:1. However, many other mixtures for dissolvable weights according to the invention are possible, using more, fewer, or additional ingredients. Colorings other than red may be used, or colorings may be omitted and one of various other visual attractants added, such as shiny fish scales. Epsom salts may be substituted for sea salt or salt may be omitted entirely. Wildlife attractants such as dried blood, fish scents, fish pheromones, fish meal, insects, dry bait, powdered grains, and other organic materials may be added to the melange, so that when it dissolves, fish or other wildlife may be attracted to the general area where the fisherman casts his line. Even without wildlife attractant added to the dissolvable weight, the invention provides an environmentally friendly advantage, in that the dissolvable weight may be composed entirely of biodegradable ingredients that quickly become diluted throughout, or disappear from the water.

The present invention also provides novel means for attaching a detachable sinker with water soluble attachment to a fishing line. Several examples of attachment means are disclosed in the following paragraphs. Generally, these attachment means include a fastening component that provides a strengthening interface between the rapidly disintegrating water soluble material and the fishing line.

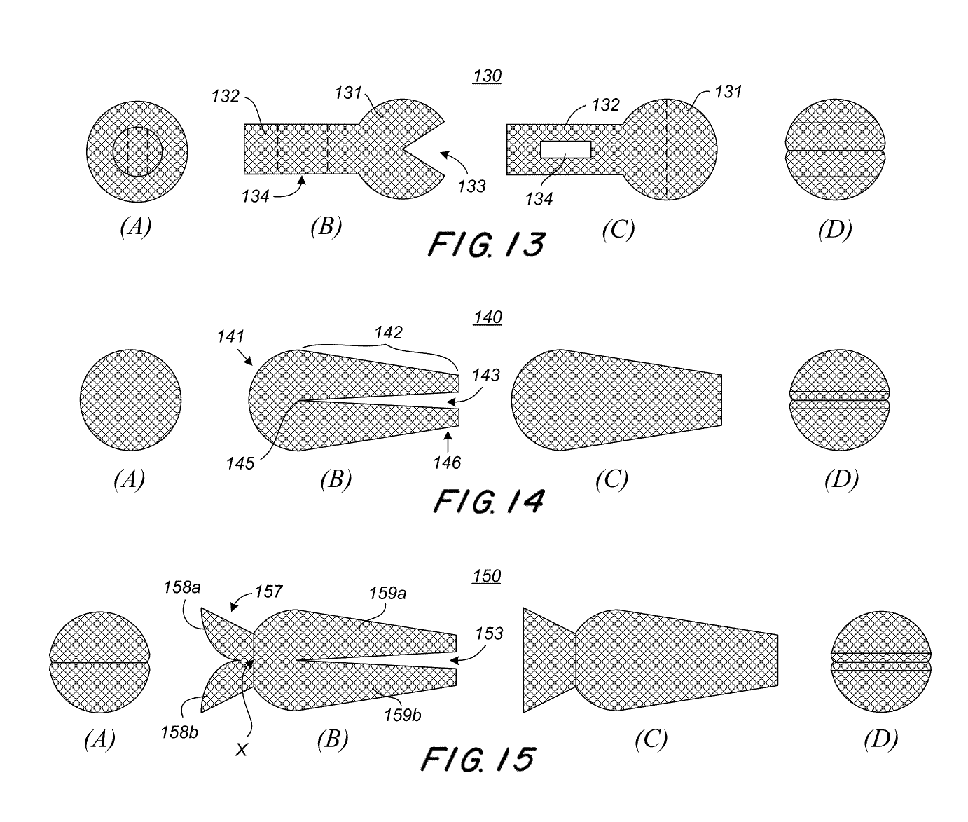

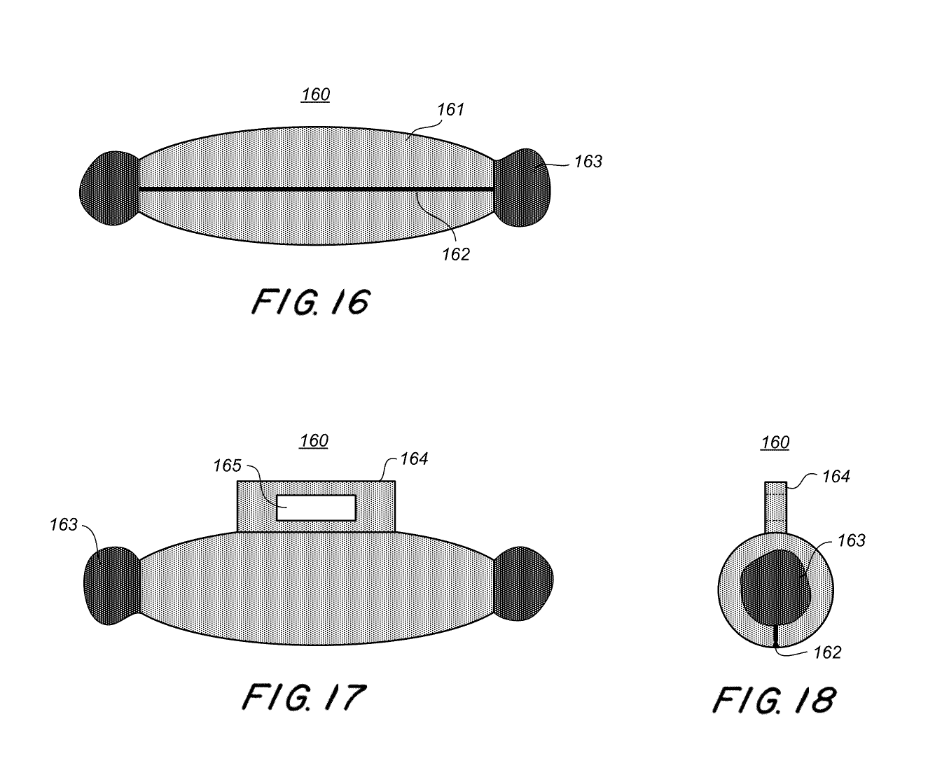

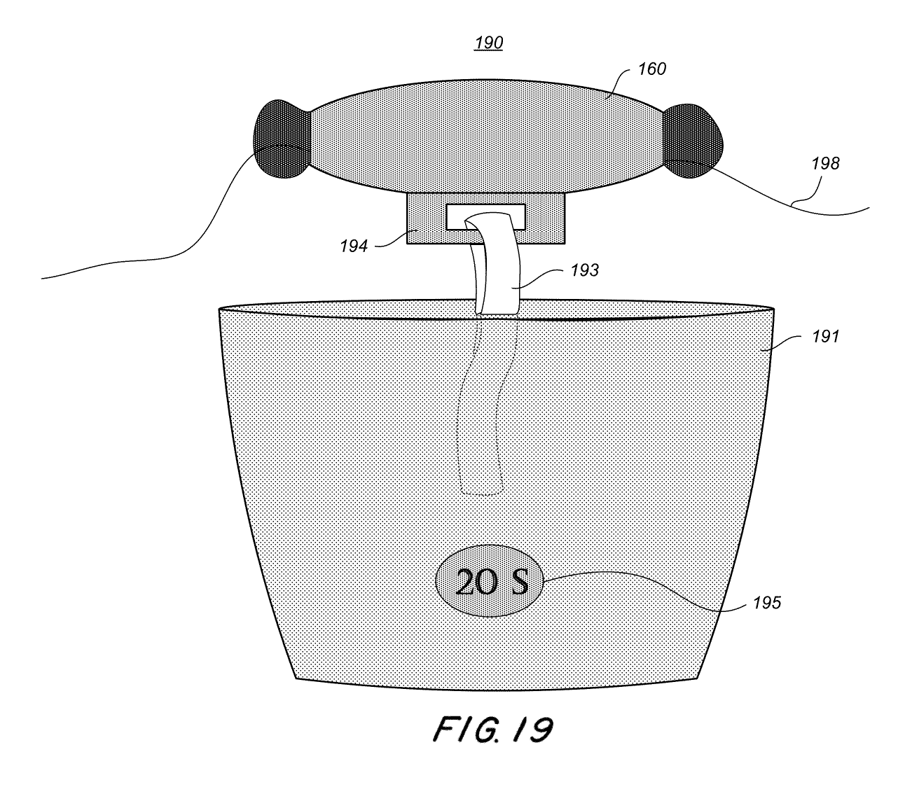

FIG. 13 shows rear (A), side (B), top (C), and front (D) views of a means according to the invention for attaching a detachable sinker according to the invention to a length of fishing line. Attachment means 130 may be described as a modified split shot, composed of a clamp portion 131 that is coupled to a sinker attachment portion 132. These portions may be formed from a single piece of material, for example, from a metal such as lead, or from an alloy of iron or lead. The material should possess sufficient softness or malleability to allow the wedge-shaped opening 133 of clamp portion 131 to be pinched shut by pliers or by the force of human fingers to compress a fishing line for attachment thereto. Sinker attachment portion 132 may be perforated by a hole 134 formed in the sinker attachment portion to facilitate attachment of a detachable sinker according to the invention. In one embodiment, hole 134 may have a rectangular shape sized to accept a strip of rapidly disintegrating water soluble material. The strip may be threaded through hole 134 during the process of manufacturing the detachable sinker, so that attachment means 130 becomes an integral part of a detachable sinker assembly.

In one embodiment, an attachment means 130 may have an overall length of about ½ in. to about 1.0 in. The diameter of the clamp portion 131 may be between about 3/16 in. and about 5/16 in. The sinker attachment portion 132 may have a length of between about 5/16 in. and about 11/16 in., with a diameter of about ⅛ in. to about ¼ in. The opening of hole 134 may have a length of about 50% to about 75% of the length sinker attachment portion 132, and may have a width of about 50% to about 75% of the diameter of sinker attachment portion 132. The wedge-shaped opening 133 may be formed by partially splitting the clamp portion about halfway through. In another embodiment, sinker attachment portion 132 may have a length about twice the diameter of clamp portion 131. All of the foregoing dimensions are approximations only, and may be scaled up or down depending on intended use.

FIG. 14 shows rear (A), side (B), top (C), and front (D) views of another means according to the invention for attaching a detachable sinker according to the invention to a length of fishing line. Attachment means 140 may be described as split bar, or as an elongated split shot, and may be composed of a single piece of metal such as an iron or lead alloy. Attachment means 140 includes a rounded portion 141 and an elongated clamping portion 142. The elongated clamping portion may extend from approximately the midpoint 145 of a hemisphere defined by the rounded portion 141, to the narrow end 146 of the elongated clamping portion. The elongated clamping portion may be divided into first and second halves separated by a wedge-shaped split or opening 143. The overall dimensions of attachment means 140 are similar to those of attachment means 130. In one embodiment, the length of the elongated clamping portion 142 is at least twice the diameter of the rounded portion.

The length of elongated clamping portion 142 should be made sufficient to accommodate and tightly compress both a fishing line and length of rapidly disintegrating water soluble material that is affixed to sinker weight according to the invention. In use, a fishing line may first be inserted into opening 143 and positioned at or near the midpoint 145. Then, a tab or other segment of rapidly disintegrating water soluble material may be inserted into the opening 143. The two halves of the elongated clamping portion 142 may then be compressed together, thereby connecting the sinker to the fishing line. The order in which the line and tab are placed within the opening may be reversed. The line and tab may also be compressed one on top of the other.

FIG. 15 shows rear (A), side (B), top (C), and front (D) views of a removable attachment means according to the invention for attaching a detachable sinker according to the invention to a length of fishing line. Removable attachment means 150 includes a rounded portion 151, an elongated clamping portion 152, and an opening mechanism 157. Removable attachment means 150 may be machined, formed, or molded from materials similar to those of attachment means 130 or 140. The dimensions of the rounded and elongated clamping portions 151 and 152 are similar to those of 141 and 142.

The opening mechanism 157 may comprise opposing hinges 158a and 158b configured to reopen legs 159a and 159b of the elongated clamping portion 152 when the elongated clamping portion is in a closed or compressed condition. Hinge 158a may be coupled to leg 159a such that rotation of hinge 158a about a fulcrum X causes leg 159a to rotate about the fulcrum in the same direction as hinge 158a, and vice versa. Similarly, hinge 158b may be coupled to leg 159b such that rotation of hinge 158b about the fulcrum X causes leg 159b to rotate about the fulcrum in the same direction as hinge 158b, and vice versa. Thus, when hinges 158a and 158b are pinched or compressed together, legs 159a and 159b rotate in opposite directions to reopen the elongated clamping portion 152, and to allow for removal of the removable attachment means from fishing line. Compression of legs 159a and 159b, for example, against a fishing line and rapidly disintegrating water soluble tab, causes hinges 158a and 158b to rotate in opposite directions to reset the hinges. The size and construction of the opening mechanism 157 may be designed to allow reopening of the removable attachment means by compressing the hinges with pliers, human fingers, or between a fisherman's teeth.

FIG. 16 shows a side view of another embodiment of a removable means according to the invention for attaching a detachable sinker according to the invention to a length of fishing line. Removable attachment means 160 includes a metal weight 161 (e.g. lead or iron-based) having a hollow core and a longitudinal slit 162 cut along the entire length of the weight and penetrating to the hollow core. The hollow interior of the weight is filled with a pliable material 163, which may be a foam rubber or other synthetic elastomer. This basic design is commonly referred to as a rubber-core sinker. This type of sinker may be removably attached to a fishing line by inserting a length of the fishing line into the slit and forcing it to a position inside the weight and away from the slit where it can be held tightly in place by pressure of the pliable material 161 against the inner wall of the weight. The fishing line can be later removed by pulling action.

FIGS. 17 and 18 illustrate how the configuration of removable attachment means 160 departs from conventional rubber-core design. FIG. 17 shows a top view of removable attachment means 160. FIG. 18 shows an end view of the removable attachment means 160. A perforated sinker attachment portion 164, which may be formed as a ring or loop 164, extends from the side of removable attachment means 160 that is opposite the slit 162. A perforation or hole 165 defined by the ring 164 provides a coupling location for a tab or loop of rapidly disintegrating water soluble material. In one embodiment, the tab or loop may be threaded through hole 165 during the process of manufacturing a detachable sinker, to make removable attachment means 160 an integral part of a detachable sinker assembly according to the invention.

FIG. 19 illustrates a removable attaching means 160 attaching a detachable sinker according to the invention to a length of fishing line. A loop of rapidly disintegrating water soluble material 193 passes through ring 194, coupling the dissolvable weight 191 of the detachable sinker to the removable attaching means 160. Fishing line 198 may then be removably attached to means 160 as previously described. The removable attachment means 160, rapidly disintegrating water soluble material 193, and dissolvable weight 191 make up a detachable sinker assembly 190 according to the invention. These components may be assembled by threading material 193 through ring 194, then partially sinking material 193 into the melange of dissolvable weight 191 prior to curing. In this particular example, dissolvable weight 191 has an indicia 195 molded or printed on an outer surface to indicate a release time. The indicia “20 S” may correspond to an approximate release time of twenty seconds.

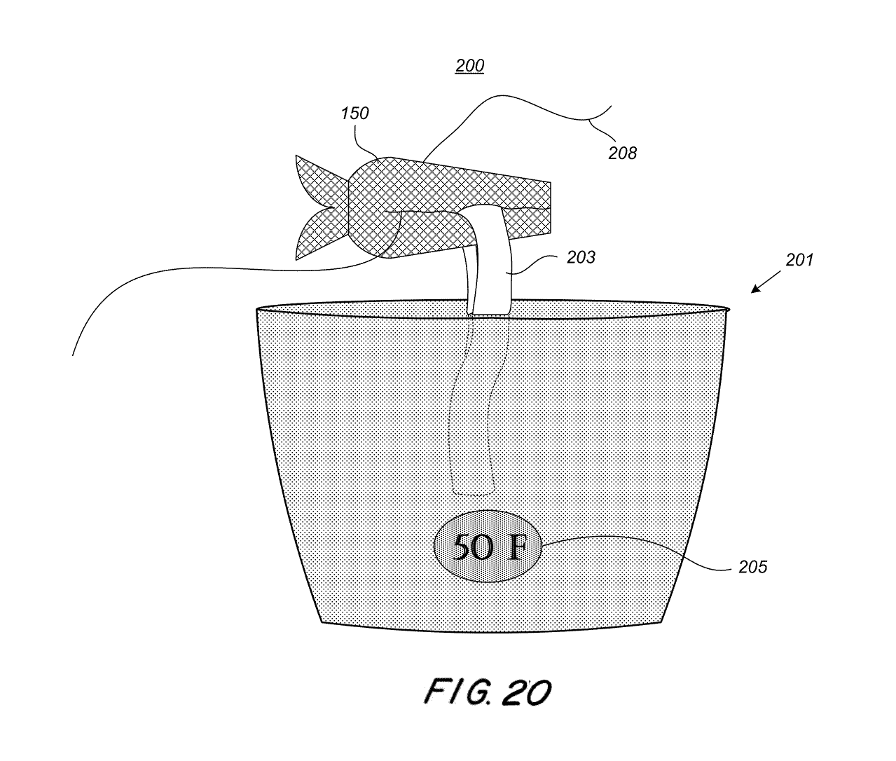

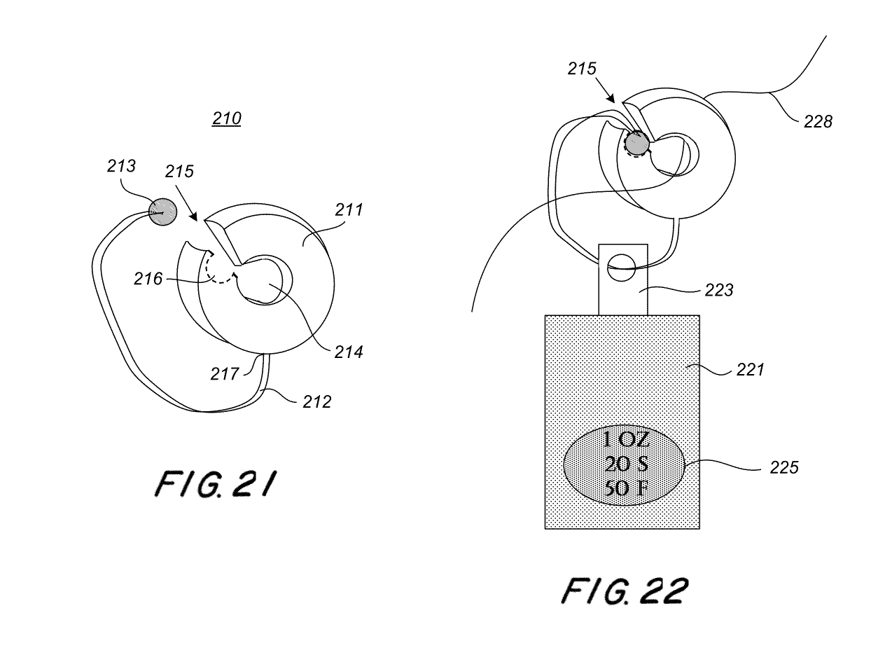

FIG. 20 illustrates an assemblage 200, wherein a removable attaching means attaches a detachable sinker according to the invention to a length of fishing line. In this scenario, the elongated removable attaching means 150 is used to clamp both the fishing line 208 and a tab or loop 203 of rapidly disintegrating water soluble material. Loop 203 is a fixed component of the detachable sinker 201, which is made as a dissolvable weight, with or without a fish attractant, according to any of the methods previously described. One advantage of this arrangement is that the removable attachment means and dissolvable sinker components may be manufactured and packaged separately. In this particular example, detachable sinker 201 has an indicia 205 marked on an outer surface of the weight to indicate a depth rating. The indicia “50 F” may correspond to an approximate depth of fifty feet to which the sinker will sink in fresh water under force of gravity before being released by disintegration of loop 23.

Another advantage is that the removable attachment means 150 is reusable, that is, it may be attached and removed many times. When a fisherman prepares an assemblage 200 and casts the line into the water, the rapidly disintegrating water soluble tab will release the dissolvable weight. When the fisherman reels the line back in, only the removable attachment means will remain attached to the line. The removable attachment means may then be removed from the line by pinching its hinges, and then used again to attach a new sinker.

Another advantage of using any of the attachment means according to the invention (such as 130, 140, and 150) is that they allow the fisherman to deploy two different weights for a single cast—the first weight being the combined weight of the detachable sinker and the attachment means, and the second weight being only the weight of the attachment means. Moreover, the fisherman may achieve this advantage using a singular assembly such as 190 or 200. Using these assemblies, a fisherman can enjoy the benefits of a greater casting distance provided by the detachable sinker, and after the sinker detaches, advantageously maintain a lesser weight on the end of the line to achieve a desired depth for the bait, or to achieve a desired resistance when reeling in, or both.

FIG. 21 shows another removable means according to the invention for attaching a detachable sinker according to the invention to a length of fishing line. Fastener assembly 210 includes a fastening ring 211, a fastening loop 212, and a fastening ball 213. Fastening ring 211 may be composed of a pliable or slightly pliable material such as plastic or metal. Fastening ring 211 may be generally circular and sized to any diameter, but will typically have a diameter of about ⅜ in. to about ⅝ in., and a thickness of about ¼ in. to about ⅜ in. Fastening loop 212 may be composed of a plastic strip or fishing line, and may have a length of about 1.0 in. to about 2.0 in. Fastening ball 213 may be composed of a solid or semi-solid plastic ball and may have a diameter of about 3/16 in. All of these dimensions are approximations only, and may scaled up or down for a particular application.

A center hole 214 is formed through fastening ring 211 to allow passage of fishing line therethrough. A fastening channel 215 is formed in the ring, and extends from the outer rim of the ring to the center hole 214. Fastening channel 215 allows for passage of fishing line to the center hole 214 so that the fastener assembly may be attached thereto without having to thread the fishing line through the center hole. To maintain the fishing line within the center hole, a recess 216 is formed along one side of fastening channel 215, as shown, so that the fastening ball 213 may be inserted by force of friction through fastening channel 215 until it locks within recess 216. The width of fastening channel 215 may be sized slightly smaller than the diameter of the fastening ball 213, so that the pliable walls of fastening channel 215 must be forced slightly apart to pass the fastening ball to the recess. The spherical portion of recess 216 may be sized at approximately the same diameter as fastening ball 213 to snugly accommodate it. When fastening ball 213 is in the locked position within the recess, it blocks the fastening channel 215 to prevent the fishing line from exiting the fastener assembly through the fastening channel. The fastening ball 213 may be connected to the fastening ring by the fastening loop 212. The fastening loop may terminate at a location 217 on the outer diameter of the fastening ring, as shown.

FIG. 22 illustrates the removable attaching means 210 attaching a detachable sinker according to the invention to a length of fishing line. To properly make this connection, a fisherman may first pass the fishing line 228 through fastening channel 215. The fastening loop 212 may then be passed through a rapidly disintegrating water soluble tab 223 that is fixed to the weight 221 of a detachable sinker, and the fastening ball 213 may then be locked into the recess. In this particular example, weight 221 has indices 225 stamped or printed on an outer surface to indicate a weight value, a release time, and depth rating. The indicia “1 OZ” may correspond to a weight value of one ounce, the indicia “20 S” may correspond to a release time of twenty seconds, and the indicia “50 F” may correspond to a depth rating of fifty feet. These indicia may apply to fresh water or salt water or both. In another embodiment, two sets of indicia may be provided, one indicating fresh water ratings and the other indicating salt water ratings.

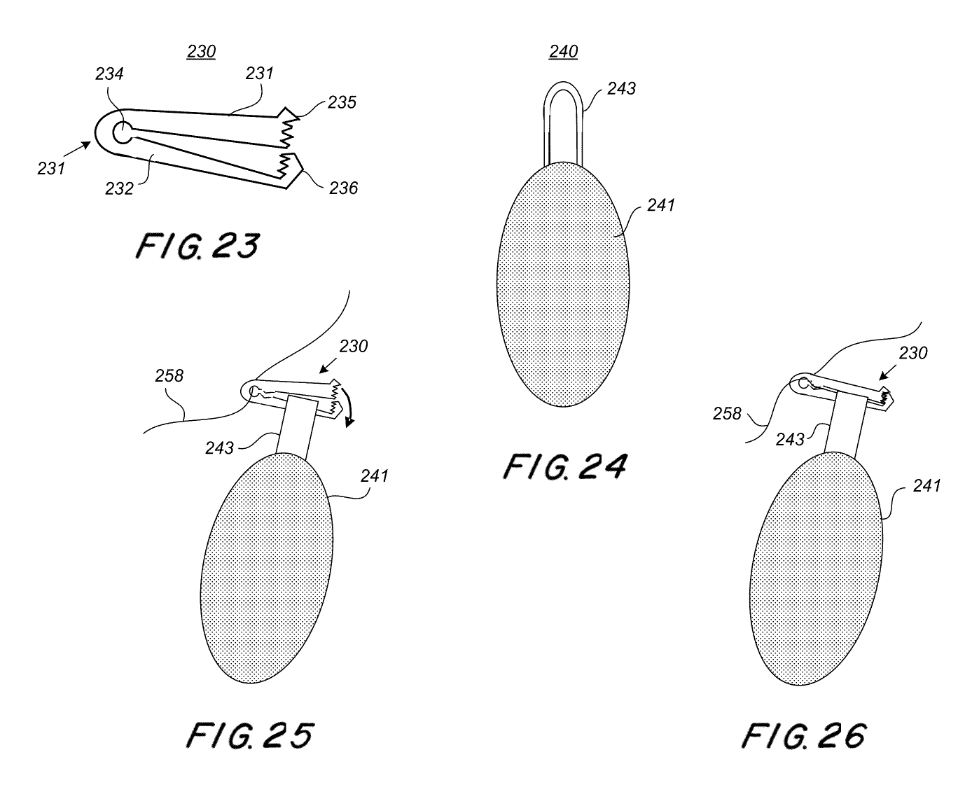

FIG. 23 shows another removable means according to the invention for attaching a detachable sinker according to the invention to a length of fishing line. The embodiment shown is a removable clip 230. Removable clip 230 may be formed from a single piece of pliable plastic or metal, and may compose two legs 231 and 232 connected at a vertex 233. Between the two legs vertex 233 defines an eyelet 234 through which a fishing line may be threaded or passed. The ends 235 and 236 of legs 231 and 232 may be serrated or configured with interlocking teeth, generally as shown, so that the ends of the legs may be pressed together into a locked position by interlocking the teeth or serrations. To unlock the legs of clip 230, the two legs may be slid apart transversely in opposite directions until the teeth disengage. The overall length of removable clip 230 may be in the range of about 1.0 to about 2.0 in.

FIGS. 24-26 illustrate how the removable attachment means 230 may be used to connect a detachable sinker to fishing line. Detachable sinker 240 includes a weight portion 241 and a rapidly disintegrating water soluble loop of material 243. Weight portion 241 may be a dissolvable sinker according to the invention that contains a wildlife attractant. FIG. 25 illustrates a fishing line 258 threaded through the eyelet of a removable clip 230. Loop 243 is shown positioned within clip 230 with the two legs of the clip 230 disengaged and resting in an open position. FIG. 26 shows clip 230 in a closed position, with the two legs fully engaged and enclosed around tab 243, so that the detachable sinker 240 is suspended from the fishing line.

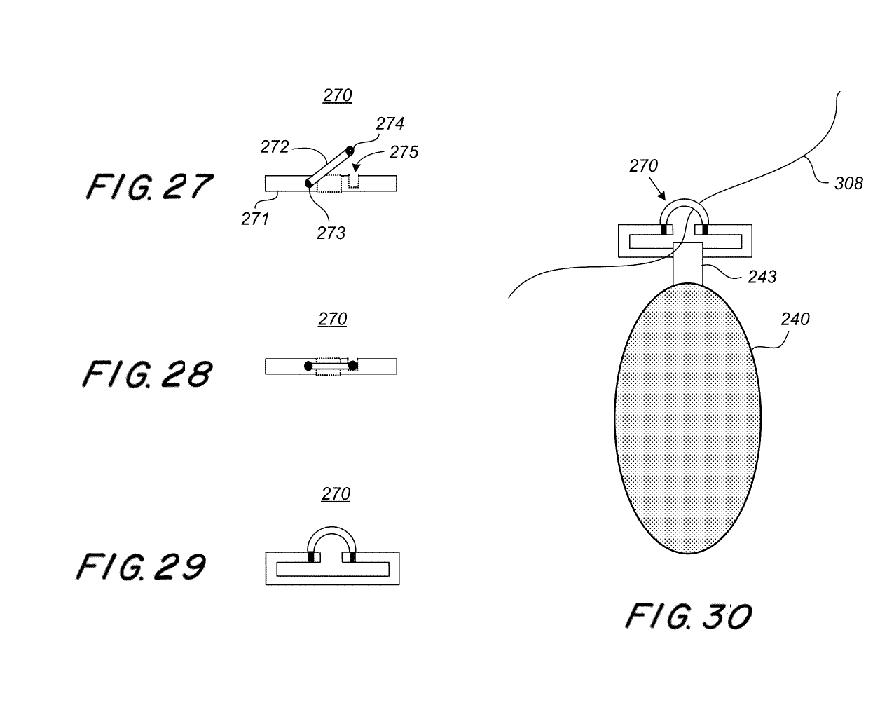

FIGS. 27-29 show another removable means according to the invention for attaching a detachable sinker according to the invention to a length of fishing line. The removable means is a metal or plastic locking clip 270, shown in an open position in FIG. 27. Locking clip 270 includes a rectangular ring 271 and a rotatable bar 272 that may be rotated with respect to the rectangular ring about a pivot point 273. Rotatable bar 272 may terminate in a pin at the pivot point, the pin being held securely within a bearing hole in the rectangular ring. A locking ball 274 may be formed at the opposite end of the rotating bar, and sized for snug insertion within a locking hole 275 formed in the rectangular ring. The overall length of clip 270 may be about 1.0 in. to about 1.5 in., with other dimensions of the locking clip being generally proportional to the overall length as shown. FIG. 28 shows a top view of clip 270 in a closed position. FIG. 29 shows a side view of clip 270 in a closed position.

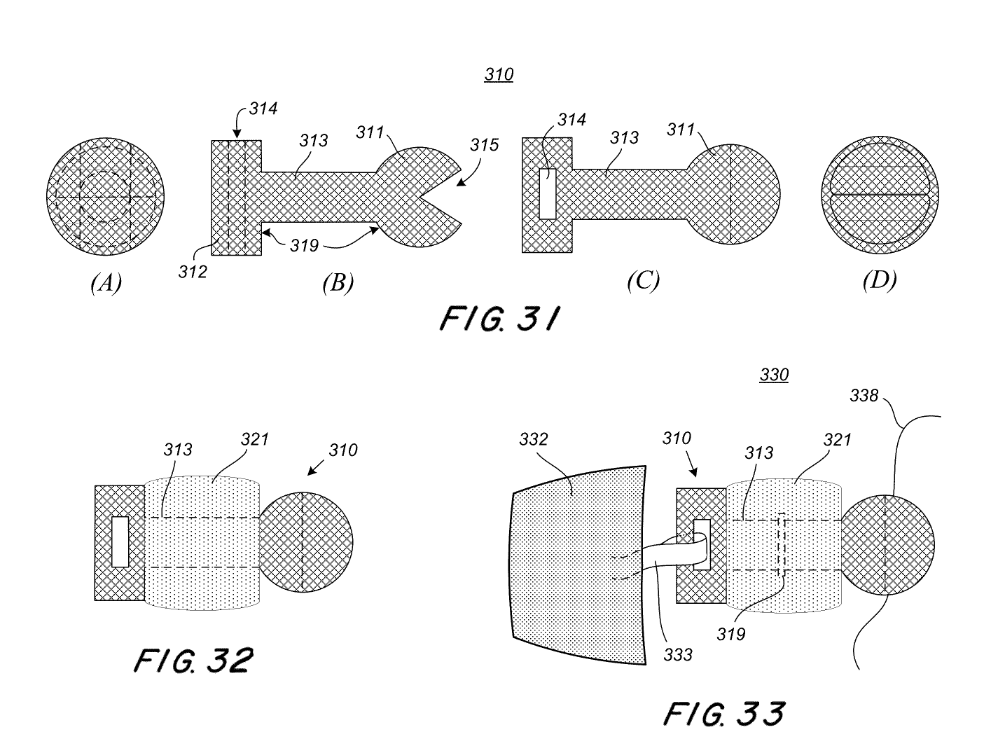

FIG. 30 illustrates the clip 270 in a closed position attaching the detachable sinker 240 to a length of fishing line. The detachable sinker 240 may be connected to the clip by coupling tab 243 to the clip in an open position, then locking the connection by closing the clip. The fishing line 308 may be threaded through clip 270 when closed, or passed through clip 270 when open.

FIG. 31 illustrates rear (A), side (B), top (C), and front (D) views of one embodiment of a means 310 according to the invention for attaching both a detachable weight and a fixed weight to a length of fishing line. Attachment means 310 may be composed of a non-disintegrating material suitable for suspending, holding, or otherwise fixing the detachable and fixed weights. In one embodiment, attachment means 310 may be composed of a compressible metal such as lead. In another embodiment, the detachable weight may be attached to the attachment means 310 by a rapidly disintegrating water soluble material, and the fixed weight may be formed or molded around a portion of the attachment means. One or both of the detachable and fixed weights may be wholly or partially dissolvable, and may also include a wildlife attractant. Generally, the dimensions of an attachment means 310 may be on the order of those disclosed for attachment means 130, 140, and 150.

Attachment means 310 illustrates one example of a component according to the invention that provides means for attaching both the detachable sinker and the fixed sinker to a length of fishing line. In the embodiment shown, attachment means 310 includes a clamp portion 311, a base portion 312, and an intermediate portion 313 connected between the clamp portion and the base portion. A hole or slot 314 may be formed in the base portion 312 to allow the detachable sinker to be tied to the attachment means. For example, a rapidly disintegrating water soluble strip may be threaded through the hole 314 for this purpose.

The intermediate portion 313 may be a cylindrical (or rectangular) length having a diameter (or width) that is less than that of the clamp portion 311 or less than that of the base portion 312. The intermediate portion provides a convenient area for locating the fixed sinker. The attachment means 310 may also include means 319 for retaining the fixed sinker. Retention means 319 may be an outer edge or outer edges of the base and clamp portions, as shown, to prevent the fixed sinker from sliding off the intermediate portion 313. In another embodiment, retention means 319 may be a flange located on the intermediate portion, the flange having a diameter or width slightly larger than that of the intermediate portion. The flange may be well suited for retaining a weight formed or molded around the intermediate portion, for example, using a melange of materials as previously described.

Clamp portion 311 may exist in an unclamped, open position, or in a clamped, closed position. In the open position shown, clamp 311 defines a wedge-shaped opening 315. To attach the attachment means 310 to a length of fishing line, a fisherman may pass a portion of the fishing line into the wedge-shaped opening 315, then squeeze the clamp portion to its closed position by compressing the fishing line between the walls of the wedge.

FIG. 32 shows a top view of the attachment means 310 with a fixed weight 321 connected to the attachment means. Fixed weight 321 may be any mass of material, such as metal, ceramic, concrete, or moldable material. Fixed weight 321 may be formed for installation on or to the intermediate portion 313 of the attachment means 310. The materials and dimensions of fixed weight 321 may be selected to add a desired weight to attachment means 310 so that the fixed weight will not easily detach from the attachment means during casting and retrieval. The fixed weight 321 may be dissolvable or non-dissolvable.

In one embodiment, fixed weight 321 may be a dissolvable weight that incorporates a wildlife attractant. In this case, fixed weight 321 may be formed or molded, for example, using a method similar to those previously described with respect to dissolvable weights 111 and 121. That is, the fixed weight 321 may be composed from a melange of wet and dry ingredients, and may include additives such as fish food, fish scales, colorings, etc. The melange may be formed or molded around intermediate portion 313, and later dried or cured.

The exemplary attachment means 310 illustrates one embodiment of a device that may be used as part of a sinker assembly 330 according to the invention. Generally, such an assembly possesses a first portion (e.g. clamp portion 311) for attaching the assembly to a fishing line, a second portion (e.g. base portion 312) for attaching a detachable sinker to the assembly, and a third portion (e.g. intermediate portion 313) for attaching a fixed sinker to the assembly.

FIG. 33 shows a top view of an embodiment of a sinker assembly 330 according to the invention that includes an attachment means 310, a fixed weight 321, and a detachable weight 332. Either or both of the weights 321 and 332 may be non-dissolvable or dissolvable and capable of supporting, suspending, containing, holding, or otherwise including a wildlife attractant. In one embodiment, fixed weight 321 may be retainably attached to an intermediate portion of attachment means 310, detachable weight 332 may be attached to a base portion of the attachment means 310 by a strip or loop of rapidly disintegrating water soluble material 333, and the attachment means 310 may attach the entire assembly to a length of fishing line 338 by clamping or another attachment technique. Thus, after casting and within seconds after sinker assembly becomes immersed in water, detachable weight 332 is released from the assembly by disintegration of the rapidly disintegrating water soluble material 333, and sinks to the bottom. During retrieval, fixed weight 321 remains attached to the fishing line as long as it resists dissolving. Using this sinker assembly, a fisherman may advantageously deploy two different weights for a single cast, one for optimal casting distance and another for optimal retrieval.

In another embodiment, a sinker assembly 330 provides a fisherman with the ability to release wildlife attractant at one or both of the casting site and the line of retrieval. For example, a wildlife attractant may be included with a detachable weight 332 that is composed at least partially of a dissolvable material, so that the wildlife attractant may dissolve after immersion and after being rapidly released from the fishing line by the rapidly disintegrating water soluble material. The wildlife attractant will thereafter diffuse throughout the water as it sinks to the bottom, and possibly after it reaches the bottom, to attract fish to the casting site. A wildlife attractant may also be affixed to the line by inclusion on or within the fixed weight 321. Fixed weight 321 may be at least partially composed of a dissolvable material, so that during retrieval, wildlife attractant diffuses through the water along the line of retrieval from the casting site back to the fisherman.

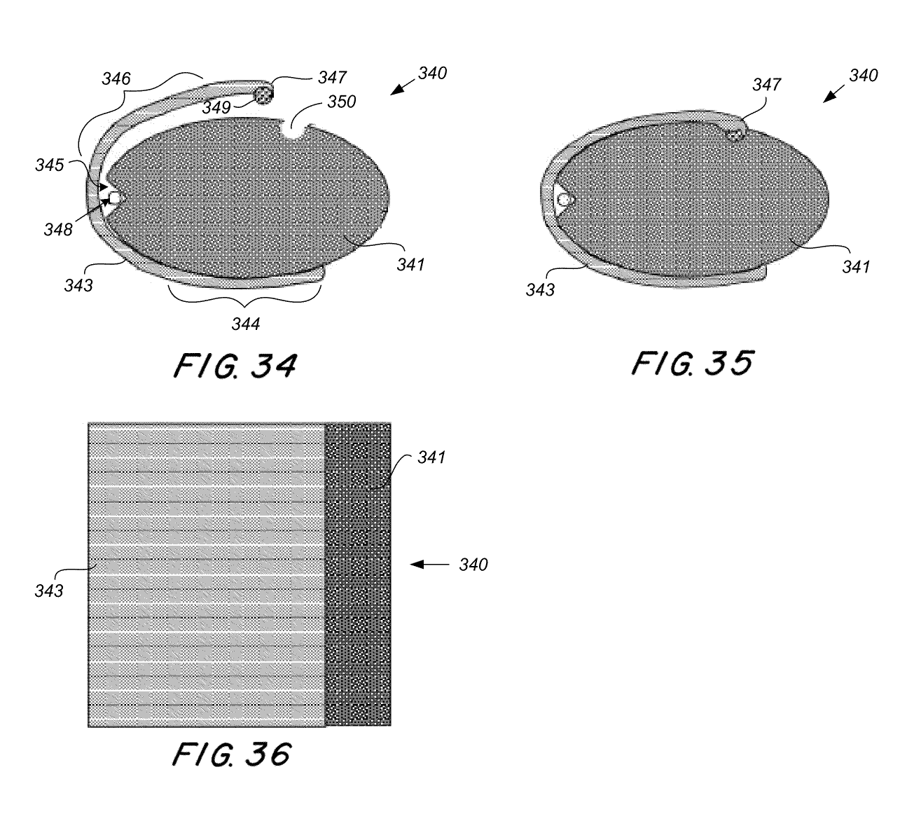

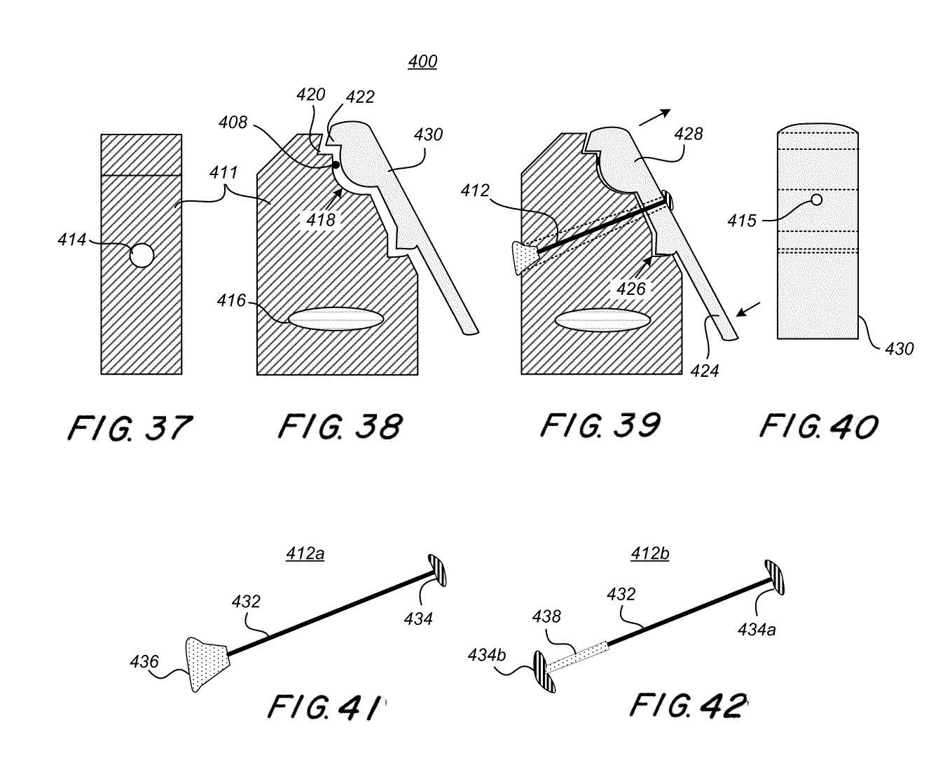

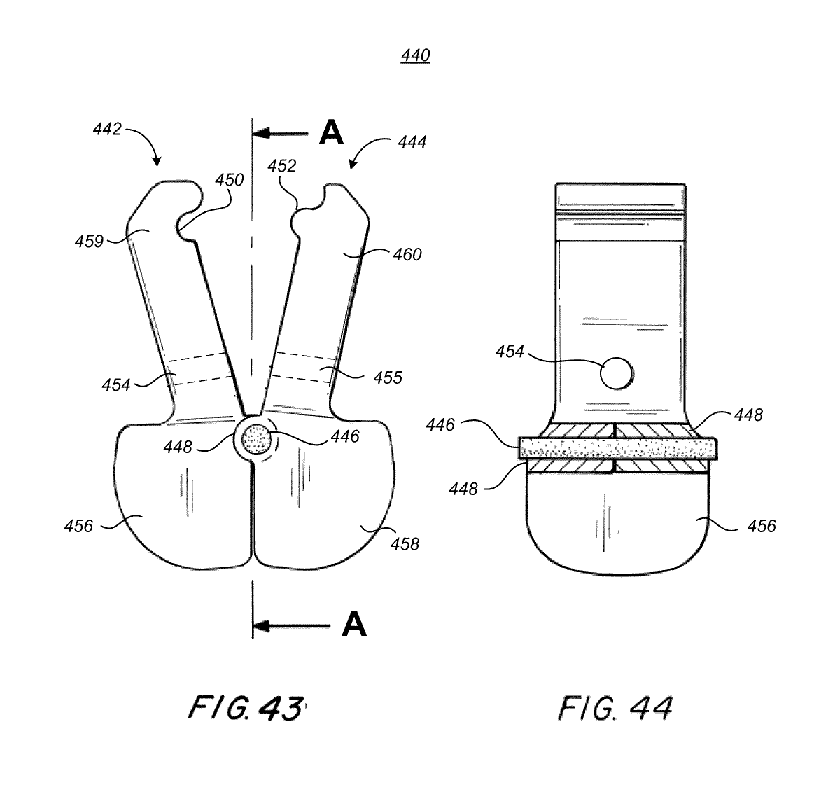

FIGS. 34-36 illustrate an embodiment 340 of a detachable sinker according to the invention that is designed for easy manufacture and easy use. Sinker 340 provides a non-toxic, environmentally friendly product that will completely dissolve in water in a short period of time. Sinker 340 incorporates both a rapid release feature for detaching a sinker from fishing line, and a targeted release of fish attractant in an around the casting site. In addition, sinker 340 provides easy attachment mechanics that allow a fisherman to quickly fix the sinker by hand to the fishing line at any location above the hook, and may also provide an aerodynamic shape for improved flight through air and retrieval through water.

FIG. 34 shows a top view of sinker 340 in an open state. Sinker 340 includes a dissolvable weight or block 341, and a rapidly disintegrating water soluble material 343 attached to the dissolvable weight 341. In a preferred embodiment, weight 341 may be composed of a moldable melange of ingredients that includes one or more wildlife attractants, as disclosed above. When cured, dissolvable weight 341 forms a solid mass that preferably features one or more aerodynamically designed surfaces to minimize resistance when the weight is drawn through a fluid such as water or air. For example, in the embodiment shown, dissolvable weight 341 is formed as a column with an oval or elliptical cross section. Other shapes are possible, and may include at least one tapered or rounded surface for promoting laminar flow along the boundary. Various sizes of weight 341 are also possible, such as 1 oz, 2 oz, 3 oz, etc.

A rapidly disintegrating water soluble strip of material 343 may be fixed to weight 341 to allow sinker 340 to assume one of two states: an open state and a closed state. In the open state, a fixed portion 344 of material 343 adheres to an intermediate portion of dissolvable weight 341, and the remaining portion, flap 346, of material 343 remains free or unattached from dissolvable weight 341. The fixed portion 344 of material 343 may adhere to the intermediate portion of dissolvable weight 341, for example, by dissolvable glue or other biodegradable, non-toxic adhesive.

A fisherman may attach sinker 340 to fishing line by first manipulating sinker 340 into the open state, i.e., by moving or peeling flap 346 away from dissolvable weight 341. The fisherman may then slip a portion of fishing line 348 into a groove 345 formed in one end of dissolvable weight 341, as indicated in the drawing. With the fishing line 348 lying within groove 345, the flap 346 may be drawn tightly against the surface of dissolvable weight 341 to cover groove 345. Flap 346 may then be bonded to dissolvable weight 341 by pressure to achieve the closed state of sinker 340 shown in FIG. 35.

In one embodiment, an end 347 of flap 346 may comprise a soft glue strip, or may include a ball of glue or other moldable adhesive mass 349. Dissolvable weight 341 may have a channel or hole 350 formed into its surface to accommodate the moldable adhesive mass 349. The dimensions of dissolvable weight 341, flap 346, moldable adhesive mass 349 and channel 350 should be selected so that when flap 346 is stretched slightly along the surface of dissolvable weight 341, moldable adhesive ball 349 may be hand-pressed within channel 350 and thereby retain flap 346 firmly in place. In this manner, the rapidly disintegrating water soluble strip 343, the moldable adhesive mass 349, and/or the channel 350 provide an attachment means for fixing the detachable sinker to the fishing line.

The moldable adhesive mass 349 may be formed from a soft, rubber-like or plastic-like material such as that used to attach credit cards to paper, and may be made of the same adhesive used to attach the rapidly disintegrating water soluble strip 343 to the intermediate portion of dissolvable weight 341. Strip 343 may have a width sufficient to cover all or a portion of the height of dissolvable weight 341, as shown in the side view of sinker 340 in FIG. 36.

As in previously described embodiments, when sinker 340 is cast into a body of water, flap 346 rapidly disintegrates, releasing dissolvable weight 341 from fishing line 348. Weight 341 may then sink toward the bottom of the body of water, dissolving as it sinks, to release wildlife attractant in the vicinity of the casting site.

Embodiments of a Detachable Clamping Sinker

FIGS. 37 to 70 illustrate embodiments of the invention that employ a clamping mechanism as a means to secure a sinker to a fishing line. These embodiments may also employ an externally exposed rapidly disintegrating water soluble material coupled to the clamping mechanism that releases the clamping mechanism by dissolving after immersion in water. Each of these embodiments is characterized by a configuration wherein the sinker comprises first and second halves that are springedly coupled and moveable relative to one another so that a fishing line may be clamped between them. It should be understood that usage of the term “half” or “halves” herein does not necessarily mean that each half of the sinker comprises fifty percent of its overall size or mass, or that the halves have identical configurations or a mirror-image relationship. Rather, these terms are more synonymous with “weighted portion” or “weighted portions”, bearing in mind that the pair of first and second halves together comprise substantially all of the weight of the sinker assembly, i.e. the combined weight of other parts of the sinker assembly is negligible relative to the weight of its two halves.

In the first such exemplary embodiment, a detachable clamping sinker 400 is an assembly that includes three main parts: a weight portion 411, an elastic tie 412, and a clamping arm 430. FIG. 37 shows a frontal view of the weight portion 411, a.k.a. weight 411. A hole 414 is defined through the weight portion partway up the front side of the weight portion, as shown. Hole 414 provides a mounting location for the elastic tie 412, which is threaded through the hole when the sinker 400 is fully assembled.

FIG. 38 shows a side view of the weight 411. This view shows the upper right edge of the weight 411 configured for mating with a similarly shaped left edge of the clamping arm 430. Weight 411 and clamping arm 430 clamp together along this mating edge to hold the sinker 400 securely to a fishing line 408. The mating edge of weight 411 may be further configured with a receiving area 418, and a notch 420 located at one or both ends of the receiving area 418, so that when the fishing line 408 is clamped in place within the receiving area, a lock 422 on clamping arm 430 engages the notch to prevent the fishing line from slipping out of the clamp.

A recessed area, or niche 416 may optionally be provided within the weight 411. Niche 416 may be configured to contain a dissolvable or releasable fish attractant, as discussed above, such as bait or an attractive scent or glitter.

The elastic tie 412 provides a tensional spring force that holds the clamping arm 430 against weight 411. FIG. 39 shows these parts held together in a clamped state, with the elastic tie 412 under minimal tension.

FIG. 40 shows a rear view of the clamping arm 430, wherein the phantom lines indicate the various edges of the clamping arm that are disposed along the opposite front or mating edge. A second hole 415 is defined in the clamping arm 430 and runs from the rear edge through to the mating edge. When assembled to the weight, the holes 414 and 415 align to form a single extended hole through which the elastic tie 412 is threaded. Two exemplary embodiments of the elastic tie assembly are shown in FIGS. 41 and 42.

A lever end 424 of the clamping arm 430 allows a fisherman to operate the clamping mechanism of the sinker 400. By depressing the lever end 424 into the weight 411, the clamping arm 430 rotates about the fulcrum 426, such that the opposite, locking end 428 rotates away from the weight 411, as indicated by the arrows. This action allows for easy removal of the sinker from the fishing line. During this action, the elastic tie 412 is stretched through the hole 414 under a greater tension that places a restoring force on the clamping arm 430. When the fisherman releases the lever end of the clamping arm, the restoring force returns the assembly to its clamped state.

FIG. 41 shows a first exemplary embodiment of an elastic tie 412a. This embodiment comprises an assembly that includes an elastic strip 432, which is connected at one end to a retaining tab 434 and at the opposite end to a dissolvable plug 436. Elastic strip 432 may be formed from material having tension spring properties such as a synthetic rubber band. Retaining tab 434 may be formed from any substantially rigid or resilient material such as metal, plastic, cork, or clay, but preferably from an organic material that will eventually dissolve in water or otherwise not introduce harmful particles into recreational waters or to wildlife. Retaining tab 434 is preferably configured in an oblong or elliptical shape that will allow the tab to be threaded through the holes 414, 415 when the tab is oriented so that its longitudinal axis is parallel with the length of the hole, and that, when threaded completely through the holes 414, 415 to the rear edge of the clamping arm, may be turned about ninety degrees so that the longitudinal axis is perpendicular to the length of the hole to prevent the retaining tab from slipping back into the hole. In other words, when the tab 434 is oriented as shown in FIG. 41, it is too wide to slip into the hole. The dissolvable plug 436 may be formed from a mass or wound-up strip of a rapidly disintegrating water soluble material as described herein. The size of the plug 436 should be sufficient to arrest it from being drawn entirely into the hole 414 when the elastic strip 432 is under tension and tending to pull the plug into the hole, as shown in FIG. 39. This configuration exposes one end of the plug 436 to the environment external to the sinker.

FIG. 42 shows a second exemplary embodiment of an elastic tie 412b. This embodiment comprises an assembly that includes an elastic strip 432, which is connected at one end to a first retaining tab 434a and at the opposite end to a dissolvable strip 438. Dissolvable strip 438 comprises rapidly disintegrating water soluble material. The dissolvable strip 438 is, in turn, connected to a second retaining tab 434b at the end of the elastic tie that is opposite the first retaining tab. The dissolvable strip 438 may be about the same diameter or of a slightly larger diameter than that of the elastic strip 432.

Elastic tie assemblies 412a and 412b operate similarly. When installed, for example, as shown in FIG. 39, the elastic tie is under tension with sufficient force to hold the mating edge of clamping arm 430 against the mating edge of weight 411 and compress a fishing line 408 between them to fix the sinker 400 to the line. When the line is cast into water, the dissolvable portion of the elastic tie, plug 436 or strip 438, is at least partially externally exposed, e.g. to water, which begins to dissolve the rapidly disintegrating water soluble material. In the case of elastic tie assembly 412a, the water first dissolves the wider, outer portion of the plug 436 and wicks inward until it weakens the bond that fastens the plug to the elastic strip 432, eventually causing the bond to break apart. In the case of elastic tie assembly 412b, the second retaining tab 434b is sized to allow water to enter the hole 414 and reach and dissolve the strip 438. Because the elastic ties are under tension, the bond between the elastic ties and the water soluble material tends to break quickly once the integrity of the water soluble material begins to weaken in water.

FIG. 43 shows a side view of an embodiment of a detachable clamping sinker 440 according to the invention. Sinker 440 comprises primarily two cooperating parts—a receiving half 442 and a plugging half 444. These weighted halves 442, 444 are rotatably coupled together by a pin 446 threaded through bearings 448. One or more bearings 448 may be formed integrally with each weighted half, for example as appurtenances formed on the weighted half through a molding or machining process. Holes 454 and 455, formed respectively through the weighted halves 442 and 444, provide a through-way for installation of an elastic tie assembly, such as either of assemblies 412a and 412b. The weighted halves 442 and 444 may be each be formed from a single piece of metal, ceramic, or sinkable plastic material.

A notch 450 formed near the distal end 459 of half 442 cooperates with a knob 452 formed near the distal end 460 of half 444. The notch 450 and knob 452 are configured to engage one another and form a lock for fixing the sinker 440 to a fishing line. In operation, with an elastic tie 412a or 412b under tension and threaded through holes 454 and 455, a pinching force applied to the proximal weighted ends 456 and 458 causes rotation of the distal ends 459, 460 about the pin 446 to separate the notch and knob, into the position shown. Fishing line threaded between the distal ends and preferably below the knob 452 may thence be clamped to the sinker upon removal of the pinching force. Removal of the pinching force (i.e. by relaxation of pressure between thumb and forefinger) allows the restoration force of the elastic member to draw the distal ends together again into an engaged position.

FIG. 44 shows a frontal view of the receiving half 442 of sinker 440 viewed along section A-A, with the pin 446 resting in place. Weighted ends 456 and 458 are preferably configured to provide the majority of the mass of the sinker, for example, between sixty and 80 percent of its total mass. The weighted ends 456 and 458 are further configured for grasping between a thumb and forefinger for one-hand operation. When the sinker 440 is clamped to fishing line and the line cast into water, the externally exposed rapidly disintegrating water soluble material of the elastic tie assembly, while under tension, dissolves, causing the elastic strip to break away and force open the distal ends 459 and 460 to release the sinker from the fishing line.

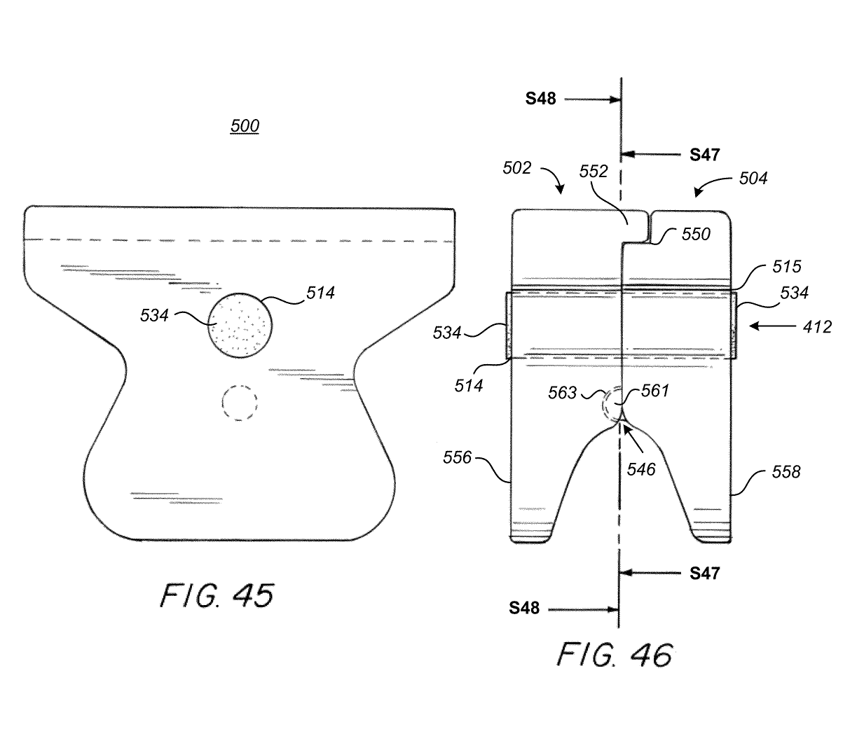

FIG. 45 shows a frontal view of an embodiment 500 according to the invention. FIG. 46 shows an outer side view of the sinker 500. Sinker 500 comprises a detachable clamping sinker configured with cooperating receiving and plugging halves 502 and 504. Its principle of operation is similar to that of sinker 440.

The two cooperating halves 502 and 504 are held together by an elastic tie assembly 512, which is under tension when the sinker 500 is in the closed position, as shown. As in the embodiments 400 and 440, the elastic tie assembly 512 is configured with plugged ends 534, one or both of which are composed of a rapidly disintegrating water soluble material. Elastic tie assembly runs through hole 514 defined in half 502 and through hole 515 defined in half 504, while plugged ends 534 hold the assembly to the sinker by friction fit within the holes while exposing at least part of the rapidly disintegrating water soluble material to the external environment.

A pinching force applied so that handle ends 556 and 558 are forced toward each other causes halves 502 and 504 to separate at the fulcrum 546, which in this embodiment comprises a ball and socket joint, with the ball 561 formed on or attached to the plugging half 504 and the socket 563 formed in receiving half 502. This action disengages lock 552 from shelf 550 to free a fishing line held therebetween. In one embodiment, the lock 552 extends transversely from an interfacing side of receiving half 502, to engage the shelf 550 that is formed as a complimentary transverse recess into the interfacing side of the plugging half 504. Release of the pinching force allows a restoring force of the elastic tie assembly 412 to draw the two halves together again and thus clamp the fishing line between the lock and shelf. At all times during compression and release of ends 556 and 558, the ball 561 rotates within and with respect to the socket 563 to help maintain halves 502 and 504 in operational alignment.

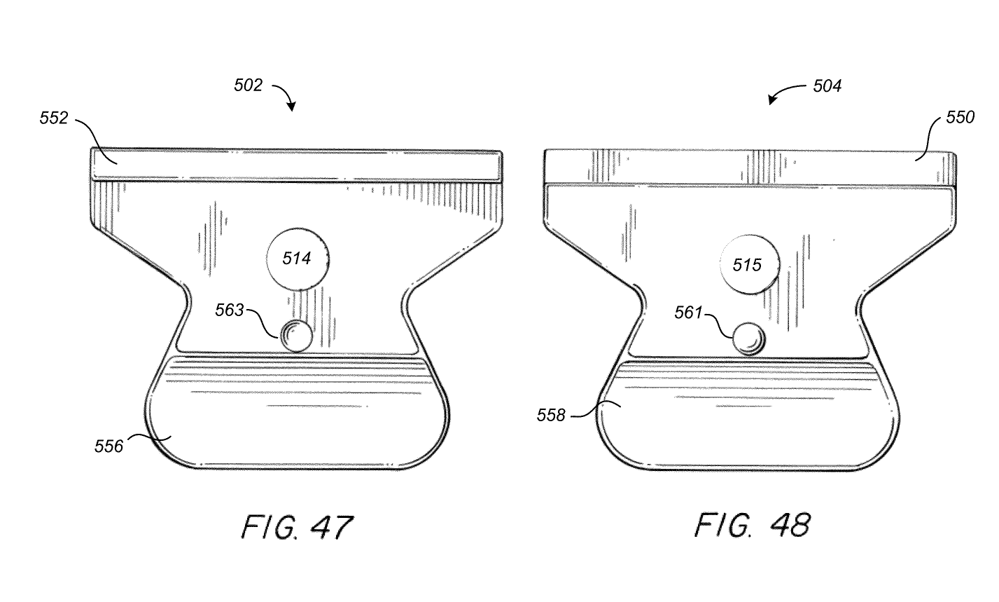

FIGS. 47 and 48 show interfacing side views, respectively, of the receiving half 502 and plugging half 504 of the sinker 500. FIGS. 47 and 48 correspond respectively to sections S47 and S48 of FIG. 46.

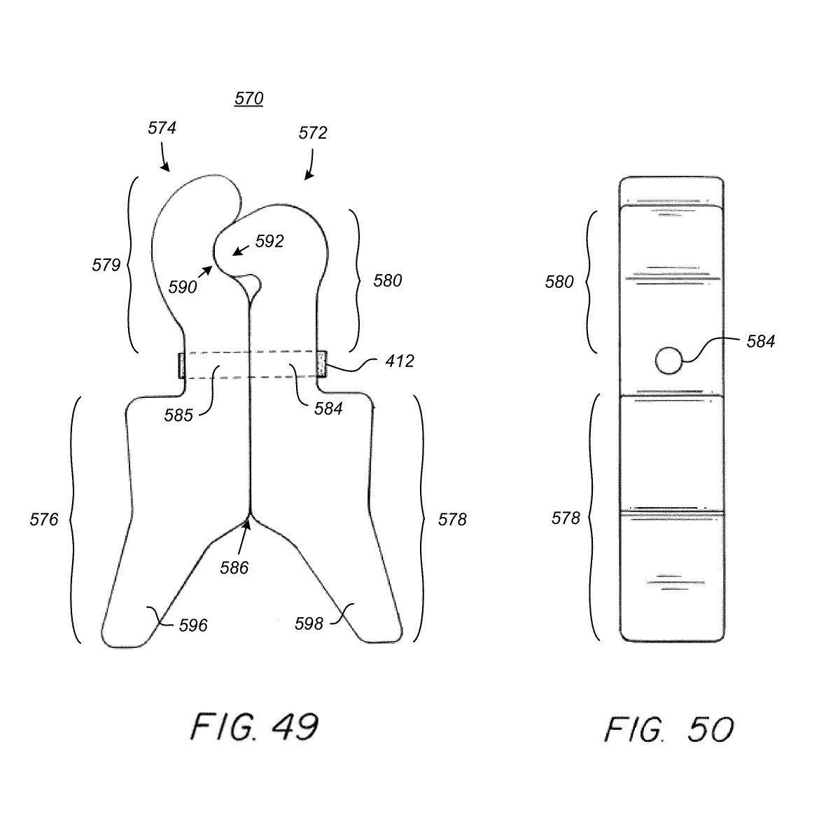

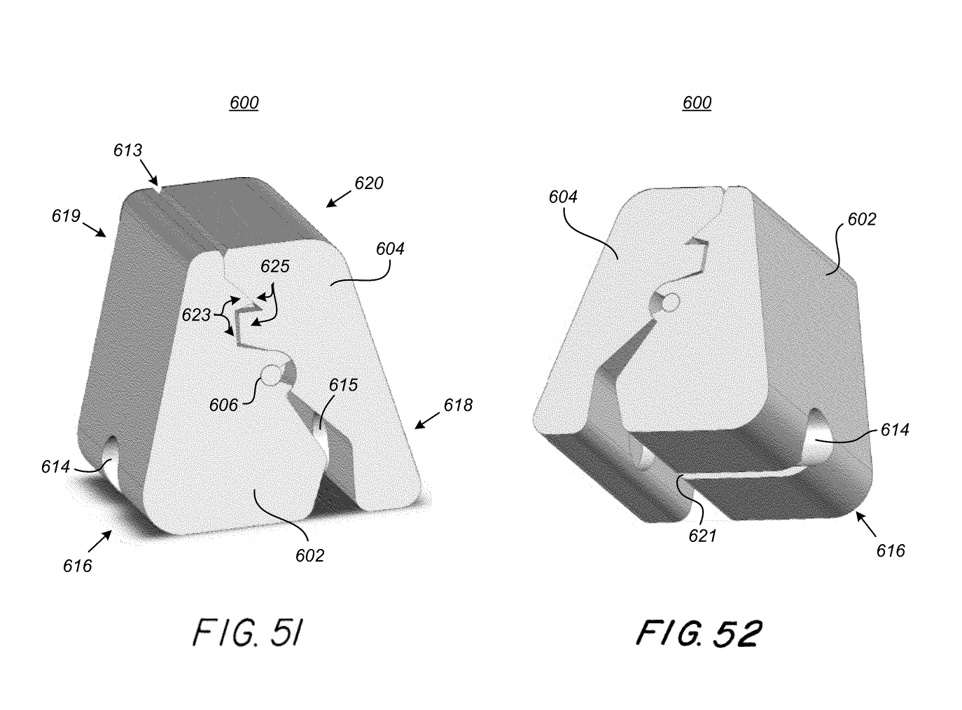

FIG. 49 shows a side view of another embodiment according to the invention of a detachable clamping sinker 570 having cooperating receiving and plugging halves. FIG. 50 shows a frontal view of the sinker 570.

Sinker 570 illustrates, generally, the main parts of a detachable clamping sinker. The sinker includes two cooperating weighted halves: a receiving half 574 and a plugging half 572. Each half has a locking distal end 579 or 580, and a proximal weighted end 576 or 578, as shown. Each proximal weighted end comprises a lever arm or handle 596 or 598 configured to allow application of a manual, one-handed pinching force that causes rotation of the weighted halves with respect to each other about a fulcrum 586. Each half defines a hole 584 or 585 between its proximal and distal end such that the hole runs transversely through the half to align with its counterpart hole. Holes 584 and 585 are located distally with respect to the fulcrum. An elastic tie assembly 412 runs through the two holes and attaches to each half by friction fit or other adhesive means, such that in the closed position (as shown) the elastic is under tension, and so that when the pinching force rotates the distal ends apart, the elastic tie imparts a restoring force that tends to pull the distal ends together. The locking distal end of the plugging half includes a lock, hook, or other protruding form 592 that is configured to engage a complimentary recess 590 in the locking distal end of the receiving half. When the sinker 570 is in the closed position, the elastic tie assembly is configured to impart sufficient tension to prevent slippage of fishing line out of the lock formed by the engagement of hook 592 from recess 590. When the sinker 570 that is clamped to a fishing line in this manner is exposed to water, the externally exposed rapidly disintegrating water soluble material that forms part of the elastic tie assembly 412 dissolves, causing disintegration of the elastic tie assembly resulting in separation of the sinker halves and subsequent release of the sinker 570 from the fishing line.

FIG. 51 is a perspective view of another embodiment according to the invention of a detachable clamping sinker 600. Sinker 600 comprises cooperating first (or “stationary”) and second (or “rotating”) weighted halves 602 and 604, respectively. Each half is preferably composed of the same homogeneous molded or machined material such as those described above. As in previous embodiments, the halves each comprise a proximal weighted end 616 or 618, and a locking distal end 619 or 620. The volume of each half gradually tapers from a more narrow size at the distal end to a broader size at the proximal end or base. This configuration creates greater mass and volume at the base, to facilitate grasping the proximal ends, and to allow fishing line to be more easily threaded within the distal ends. A beveled edge 613 may be formed at the top of the sinker on one or both of the stationary and rotating halves to guide the fishing line into the clamp.

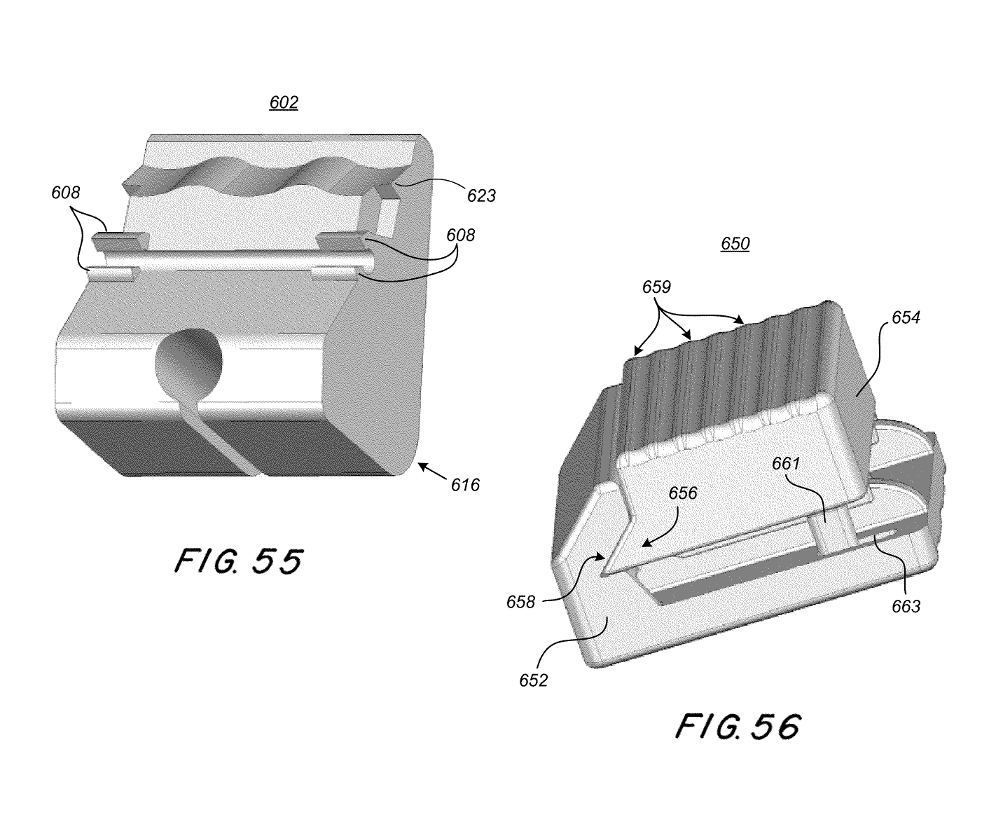

The two halves 602 and 604 are rotatably connected by means of a pin 606 and a bearing 608. In the embodiment shown, the pin 606 is part of, or is formed integrally to the rotating half 604, as shown in FIG. 54. Accordingly, the bearing 608 is part of, or formed integrally to the stationary half 602, as shown in FIG. 55. The pin-and-bearing connection locates a fulcrum coincident with the pin.

Sinker 600 is further characterized by hole 614 and recess 615 that are located proximally with respect to the fulcrum. Hole 614 is formed all the way through the proximal end 616. Recess 615 is formed on an inside wall of proximal end 618, and extends only part-way through the wall. Hole 614 and recess 615 align to allow installation of a compression tie assembly (not shown). The compression tie assembly is similar in form to the elastic tie assembly 412a or 412b, except that the elastic strip 432 is replaced by a compression spring, or a compressible material that has spring-like properties. For example, one end of the compression tie assembly may include a compression spring or a rubber material such as a synthetic rubber disk or cylinder. This spring may be affixed within the recess 615. The remainder of the compression tie assembly may include a length of rapidly disintegrating water soluble material that is connected to the spring, and that runs through the hole 614 to a plug that makes a compression fit within the hole and that exposes part of the rapidly disintegrating water soluble material to the external environment. In the closed position (as shown), the compressive tie assembly is under compression while forcing proximal weighted ends 616 and 618 apart. By squeezing together the proximal weighted ends, for example, through one-handed manual action, an additional compressive and restoring force is placed on the spring while the distal end of the rotating half rotatably separates from the distal end of the stationary half to allow the sinker to be clamped to a fishing line.

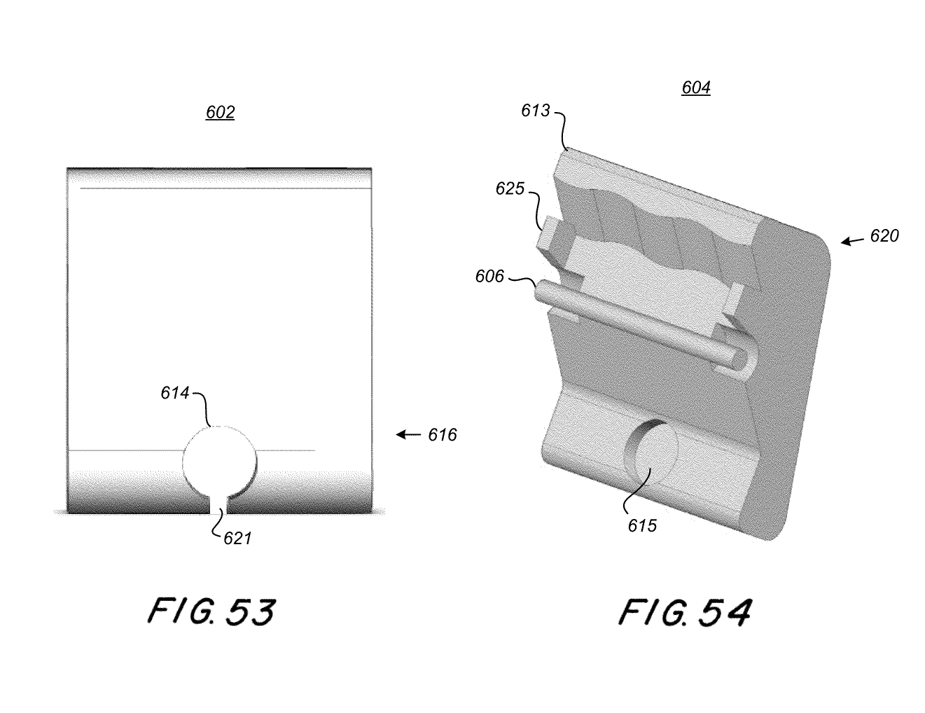

As shown in the lower perspective view of FIG. 52, and in the frontal view of FIG. 53, the proximal end 616 of the stationary half 602 is configured with a channel 621 formed in the bottom of the proximal end, and running through to the hole 614. This configuration exposes the rapidly disintegrating water soluble material of the compression tie assembly to water when the sinker is immersed therein. In such an environment, disintegration of the water soluble material releases the compressive force that holds apart the proximal ends, allowing the distal ends to unclamp and release the sinker from the fishing line.

Cooperatively engaging jagged or angled edges 623 and 625 comprise a lock or fishing line locking means for maintaining the fishing line clamped between the distal ends, i.e. to prevent a clamped fishing line from slipping out. Such edges may comprise one or multiple transversely oriented protrusions or recesses on either inner wall of a distal end, as shown.

FIG. 56 is a perspective view of another embodiment according to the invention of a detachable clamping sinker 650. Sinker 650 is characterized as having cooperating first (or “stationary”) and second (or “sliding”) weighted halves 652 and 654. In FIG. 56, sinker 650 is shown in its closed or shelf position. In this position, sliding half 654 is fully engaged with stationary half 652 and held thereto by an elastic tie assembly 712a or 712b, which is a tension spring that operates similarly to the elastic tie assembly 412. The sliding half 654 is configured with a tapered jaw 656 that protrudes from the lower front face of the sliding half, so that when fully engaged, the jaw 656 abuts a complimentary tapered receptacle 658 that is formed on a rear-facing side of the stationary half 652, as shown. When dry, i.e. when the sinker is not exposed to water, the sliding half 654 may be pulled against the tension of the elastic tie assembly to separate the halves while maintaining a restoring force that will cause re-engagement of the halves upon removal of the pulling force.

To assist a user in gripping the sliding half 654 to effect separation, the upper surface of the sliding half may be corrugated, that is, configured with one or more corrugations 659, or otherwise configured with an uneven or abrasive gripping surface. A first slot-and-rail system limits the travel of the sliding half 654 with respect to the stationary half 652 during separation. The first slot-and-rail system includes vertical rails 661 descending from opposing sides of the bottom rear surface of the sliding half 654. Cooperating slots 663 are defined within the upper rear surface of stationary half 652, on opposing sides thereof, as shown. The rails 661 are thus slidably inserted within the slots 663 to limit the longitudinal displacement of the sliding half 654 with respect to the stationary half. Each slot 663 is configured with closed ends to limit the travel of the vertical rails. The length of each slot 663 is selected so that in the furthest forward position, the elastic tie assembly remains under tension sufficient to compress or clamp a fishing line between the halves against the tapered jaws 656 and 658. The length of each slot 663 is further selected so that in the furthest rearward position, the elastic tie assembly withstands a higher tension that imparts the restoring force on the halves without deforming the elastic tie assembly.

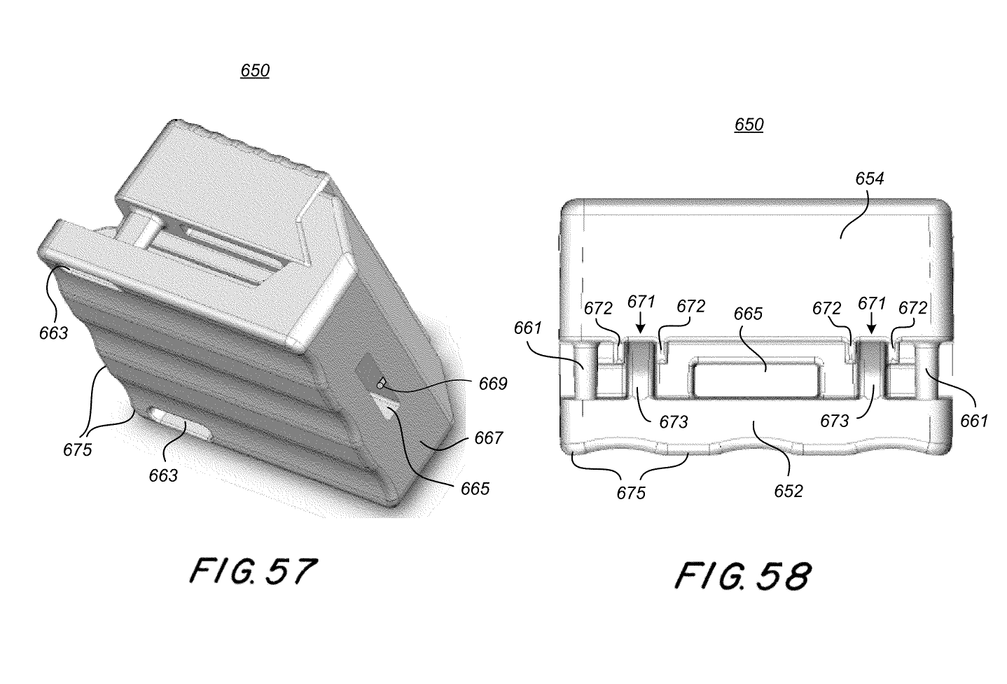

In one embodiment, the slots 663 may run all the way through the lower rear portion of the sliding half, as shown in the lower perspective view of FIG. 57. This view also illustrates an optional configuration of a recessed shelf 665 formed on the rear wall 667 of the sliding half. The recessed shelf may be configured to allow insertion or installation of a fish attractant as described in prior embodiments. Shelf 665 may also provide a location for attaching a hook 669 to the body of the stationary half. Hook 669 provides an anchoring point for installation of one end of the elastic tie assembly.

FIG. 58 is a frontal view of the sinker 650 illustrating additional features of the invention. This view shows the sinker configured with a second or longitudinal slot-and-rail system for maintaining longitudinal alignment of the sliding half 654 as it moves with respect to the stationary half 652. The longitudinal slot-and-rail system includes longitudinally oriented slots 671, each defined between dual vertically descending longitudinal rails 672 that are formed on the underside of the sliding half 654. A cooperating vertically ascending rail 673 formed on an upper surface of the stationary half 652 engages each slot 671, as shown, and is free to travel longitudinally within the slot. Thus, when the sinker 650 is assembled, the second slot-and-rail system allows longitudinal movement, while restricting transverse movement, of the sliding half 654 with respect to the stationary half 652.

The frontal view of sinker 650 also illustrates optional corrugations 675 that may be formed on the underside of the stationary half 652 to provide a better grip for a user when separating the halves of the sinker by hand.

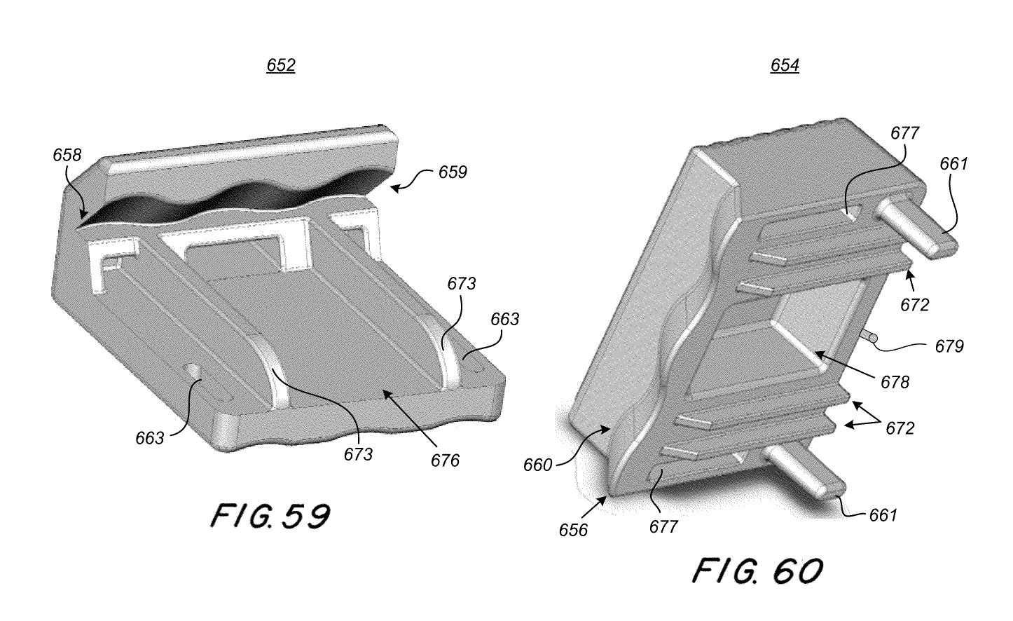

FIG. 59 is a frontal perspective view of the stationary half 652 of the sinker 650. This view reveals a channel 676 that is defined between the vertically ascending rails 673. The sinker is configured so that the foremost end of channel 676 remains open to the environment, whether the sinker is in a closed or open position. In operation, this configuration externally exposes the rapidly disintegrating water soluble material by allowing water to enter the interior of the sinker to react with the rapidly disintegrating water soluble material of the elastic tie assembly 712 a or 712b. The view also illustrates that each vertically ascending rail 673 may be formed with a curved forward end, as shown, to assist in assembling the sliding half to the stationary half. The curved end allows the sliding half to be angled upward, temporarily, to allow hook 679 to reach and connect to one end of an elastic tie assembly prior to engaging the jaws 656 and 658.

FIG. 59 also illustrates a wave-like surface 659 formed on the underside of the jaw 658. The wave-like surface 659 includes a series of alternating protrusions and recesses in a pattern runs transversely across the jaw. This pattern is configured to engage with a complimentary series of alternating recesses and protrusions 660 formed on the top surface of the jaw 656 of the sliding half 654, as shown in FIG. 60. The patterns 659 and 660 facilitate proper alignment of the two halves responsive to engagement thereof responsive to the restoring force of the elastic tie assembly. The patterns 659 and 660 comprise a fishing line locking means that ensure that a fishing line threaded between the jaws will be tightly clamped between at least one complimentary pair of protrusions and recesses. One or more of the protrusions or recesses may be manufactured slightly offset to ensure a tight grip in the closed position, or alternatively, manufacturing tolerances for these patterns may be relaxed to achieve the same result.

The perspective view of FIG. 60 also illustrates recesses 677 and 678 that may be formed into the sliding half to reduce its overall weight, or to otherwise adjust the overall weight to a desired value. One or more hooks 679 may be attached near one of these recesses, as shown, for linking to a forward end of an elastic tie assembly 712 a or 712b.

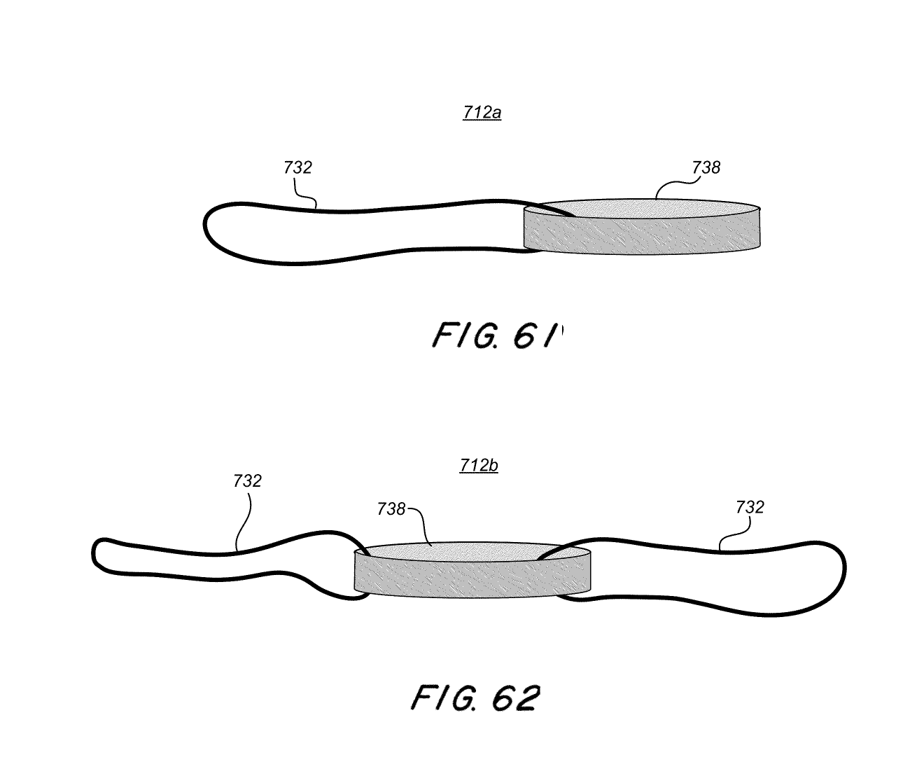

FIG. 61 depicts one embodiment of an elastic tie assembly 712a. Generally, the assembly 712a operates similarly to assembly 412a or 412b, as previously described. Assembly 712a consists of an elastic band 732 and a loop 738 of rapidly disintegrating water soluble material. The band and loop are linked together, as links in a chain. The elastic band 732 may be composed of synthetic rubber or similar material that possesses elastic, resilient spring-like qualities. The length and thickness of the band 732 are selected so that when attached to a clamping sinker such as sinker 650, the band imparts sufficient tension between the two weighted halves of the sinker to tightly clamp in place a fishing line threaded therebetween. Additionally, the length and thickness of the band 732 are selected to that it places a restoring force between the halves when the halves are in the open position, without deforming or breaking the elastic band. Loop 738 may be composed of water soluble paper as described in previous embodiments. The water soluble paper of loop 738 may be formed from a singular sheet or layer, or may be formed from multiple sheets or layers of paper. The thickness of the water soluble paper, or the number of layers, may be selected to achieve a desired depth rating or timing rating at which the paper disintegrates when simultaneously subjected to immersion in water and the tension of the elastic band.

FIG. 62 shows another embodiment of an elastic tie assembly 712b. In this embodiment, two elastic bands 732 are linked to a loop 738 of rapidly disintegrating water soluble material. This dual-band arrangement allows the designer more freedom to place the loop 738 at desired locations within the interior of the sinker. For example, the loops 733 may be of equal or unequal length so that the loop 738 can be positioned within the sinker for optimal protection when not in use, or for optimal exposure to water when deployed. The dual band design also facilitates installation of the elastic tie assembly to the sinker, and allows an assembler to handle and install the tie assembly without exposing the loop to moisture or oils transmitted by hand. Linking a band 732 to a loop 738 may be achieved, for example, by threading a strip of single or multi-layered water soluble paper through the elastic band, then using an appropriate glue or bonding agent, preferably water soluble, to complete and seal the paper loop.

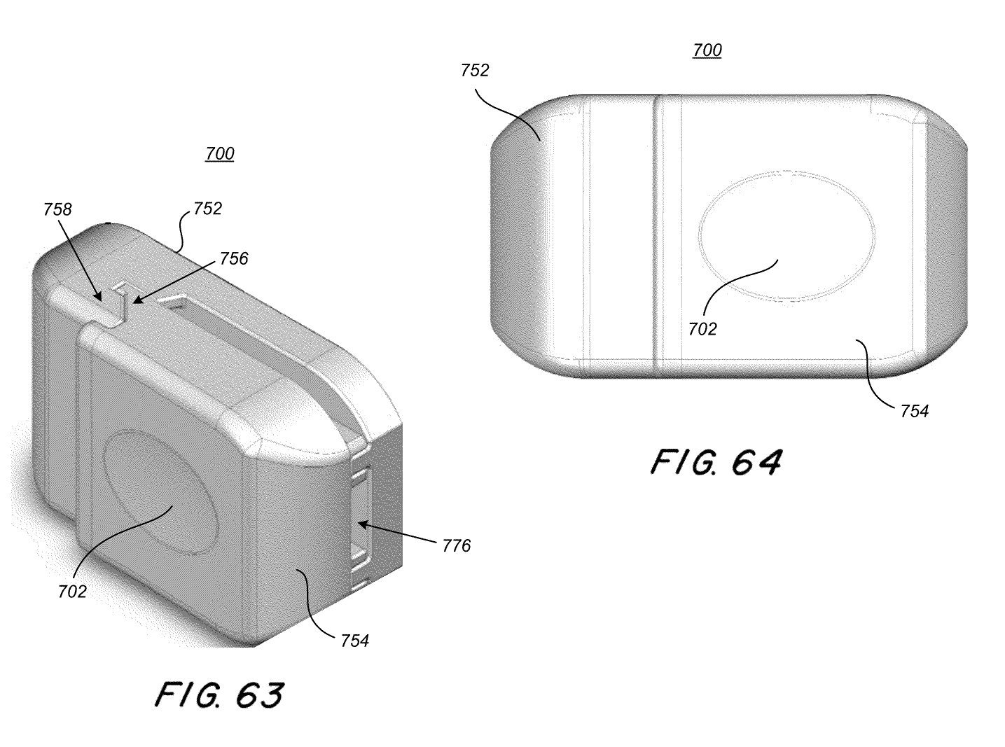

FIG. 63 is a perspective view of another embodiment of a detachable clamping sinker 700 according to the invention. The general assembly, mechanics, and principles of operation of sinker 700 are similar to those of sinker 650. Sinker 700 includes a first (or “stationary”) half 752, a second (or “sliding”) weighted half 754, and an elastic tie assembly 712a or 712b. In the closed position, as shown, a slanted lower jaw 756 on the sliding half 754 engages a slanted upper jaw 758 to clamp a fishing line therebetween. The slanted upper and lower jaws thereby comprise a fishing line locking means for maintaining a fishing line in a clamped condition. Channel 776 is provided for externally exposing the water soluble connector to salt water or fresh water. In lieu of corrugations, sinker 700 includes an oval recess 702 that is formed in the upper surface of the sliding half 754, to provide a gripping location when pulling the sliding half into the open position.

FIG. 64 is a top view of sinker 700. This view illustrates an embodiment wherein the recess 702 is centered within the borders of the top surface, and sized and shaped to accommodate, substantially, the shape of a user's thumb.

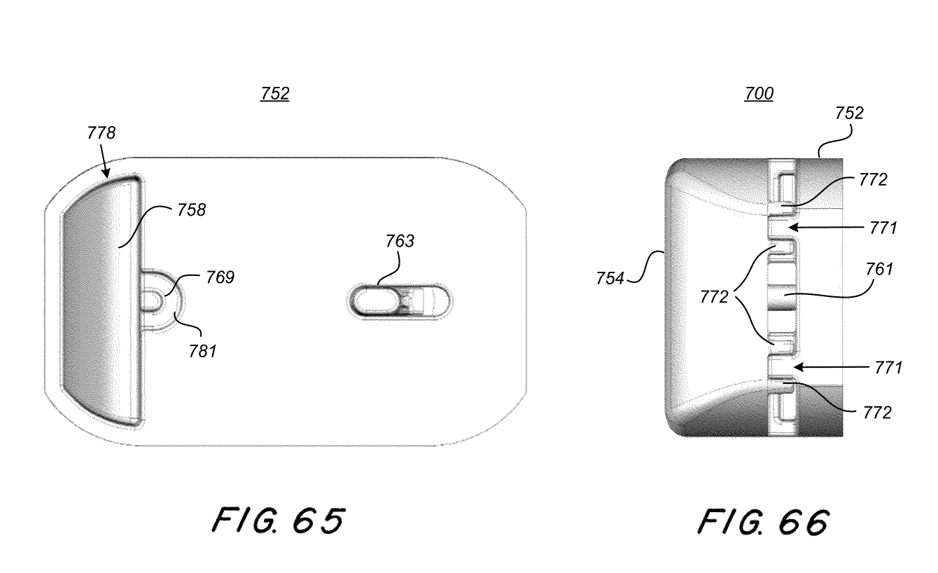

FIG. 65 is a bottom view of sinker 700. Channel 778 is open through the bottom surface of the stationary half, and so the view of FIG. 65 reveals the underside of jaw 758 as seen through the bottom surface looking up. A hook 769 may be formed in the body of the stationary half on its lower surface in a location adjacent to the channel 778, as shown. The hook 769 may be formed by machining a semicircular channel 781 around the perimeter of the hook. The hook provides an attachment point for one end of an elastic tie assembly 712a or 712b. A slot 763 is formed through the stationary half 752 for engaging a central rail 761. When the two halves are assembled, the central rail 761 extends into the slot 763 to limit both transverse and longitudinal the displacement of the sliding half with respect to the stationary half. The central rail may also provide an anchoring point for the forward end of an elastic tie assembly 712a or 712b. For example, an elastic band 732 may be looped to the central rail.

Slot-and-rail configurations are also provided to either side of the central rail 761. These configurations are shown in the end view of the sinker 700 in FIG. 66. As shown in the figure, vertically ascending rails 771 each fit within a slot formed between a pair of vertically descending rails 772. Rails 771 ascend vertically from an upper surface of the stationary half 752, while rails 772 descend vertically from a lower surface of the sliding half 754. Rails 771 and 772 run longitudinally along the sinker. The slot-and-rail configurations maintain proper alignment of the two halves of the sinker during translation of the sliding half.

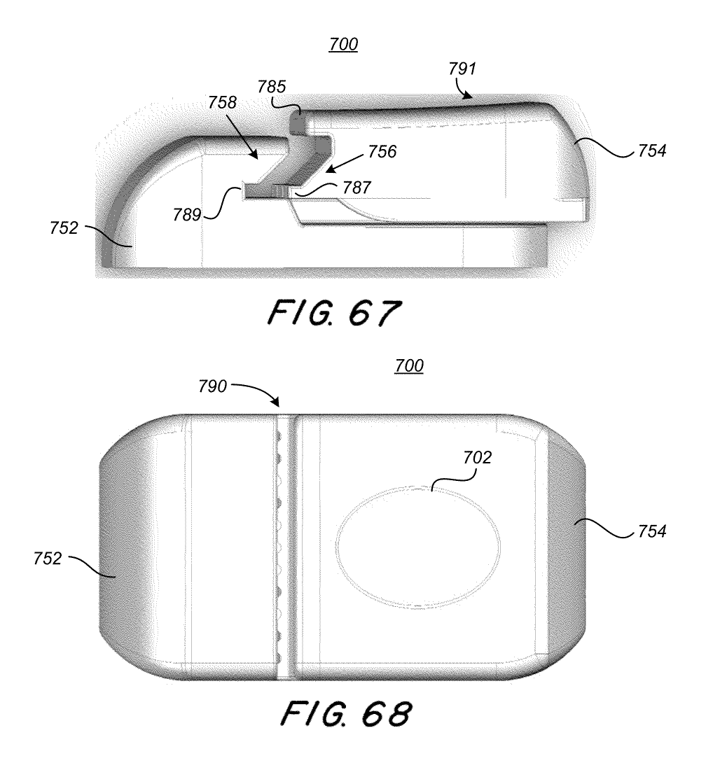

FIG. 67 is a side view of sinker 700, shown in an open position. In this position, the sliding half 754 has been displaced from the stationary half 752 in a longitudinal direction against the restoring force of an elastic tie assembly. Thus, the slanted upper jaw 758 has been separated from the slanted lower jaw 756, creating a gap 790 into which a fishing line may be threaded. Release of the sliding half will then clamp the fishing line to the sinker. To assist in maintaining the fishing line securely clamped, the sliding half 754 is configured with a fishing line locking means comprising an upper shelf 785 and a lower shelf 787 that border or enclose the upper and lower surfaces of the slanted upper jaw 758 when the sinker is in the closed position. The lower surface of the slanted upper jaw 758 is configured with a recessed shelf 789 that is sized to engage the lower shelf 787. In one embodiment, the upper surface of the sliding half 754 is configured at the front end with an upward sloping upper surface 791, to assist a user in manipulating the sliding half. FIG. 68 is a top view of sinker 700 in an open position, showing the gap 790.

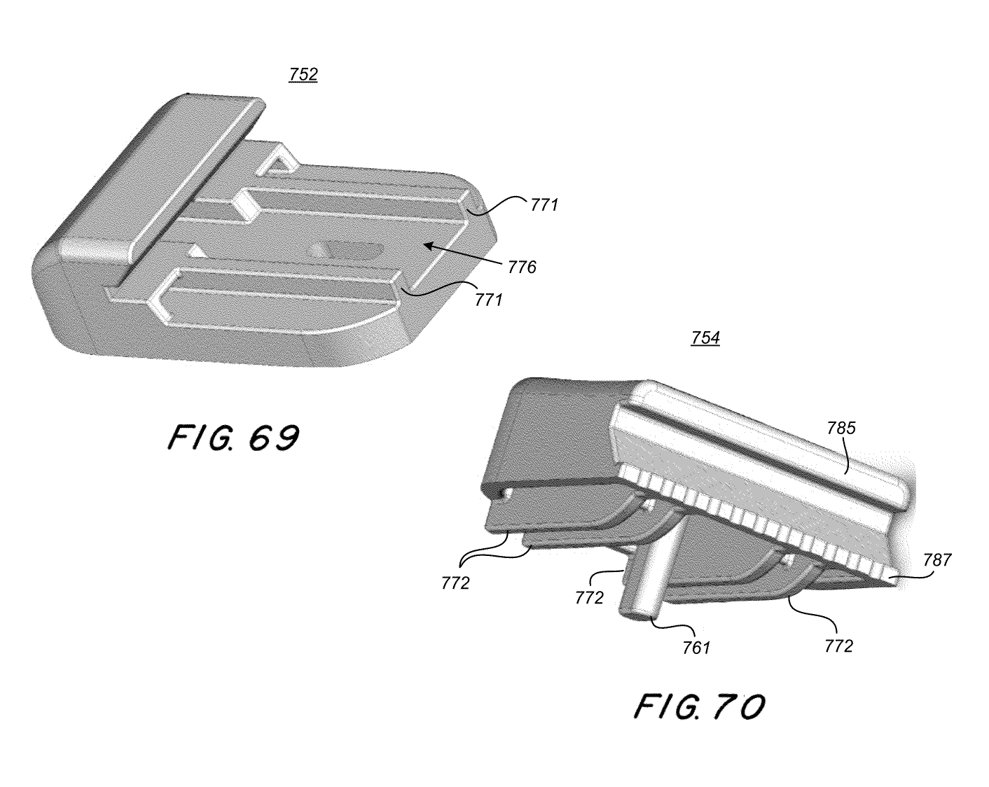

FIG. 69 is a top perspective view of the stationary half 752. In particular, this view illustrates the longitudinally running, vertically ascending rails 771. The channel 776, which allows water to enter the interior of the sinker to react with the water soluble portion of the elastic tie assembly, is formed between the rails 771.

FIG. 70 is a perspective view of the sliding half 754. This view illustrates the longitudinally running, vertically descending rails 772 and central rail 761. In one embodiment, the lower shelf 787 may be corrugated, as shown, for providing a gripping surface for contacting a fishing line.

Many advantages may be realized for fishermen and others having similar interests by using a detachable sinker according to the invention. These advantages include: (1) the ability to cast line further from shores, piers, wharfs, jetties, boats, etc., to reach more fertile fishing areas; (2) the ability to cast lightweight bait more precisely; (3) relief from the burden of weight tied to a fishing line after the baited end of the fishing line enters the water; (4) allowing greater freedom of movement for bait (both live and non-live) during presentation to aquatic wildlife; (5) improving the dynamic action of bait, particularly spinners, that require uninhibited travel through water for optimal presentation to aquatic wildlife; (6) providing materials of construction that are environmentally friendly; (7) the ability to automatically release a variety of fish or wildlife attractants when the sinker enters the water to improve the chances of catching fish; (8) the ability to sink bait to a desired depth before releasing weight to allow the bait to assume its natural buoyancy and mobility; (9) the ability to deploy two different weights for a single cast, one for optimal casting distance and another for optimal retrieval; and (10) reducing the probability of snagging the fishing line on the bottom of the body of water. The latter advantage improves the chances of successfully retrieving fishing devices and baits that are cast out, thus saving time otherwise lost rebaiting and untangling the line. Moreover, fewer snags means that the fisherman can spend more time with his hook in the water, thereby increasing the odds of catching a fish.

Exemplary embodiments of the invention have been disclosed in an illustrative style. Accordingly, the terminology employed throughout should be read in an exemplary rather than a limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A detachable clamping sinker, comprising:
a first weighted half;
a second weighted half moveable with respect to the first weighted half; and
an elastic tie assembly coupling the first weighted half to the second weighted half, the elastic tie assembly including an elastic member and an externally exposed rapidly disintegrating water soluble material linking the elastic member to one of the weighted halves;
wherein the elastic member imparts a force holding the first weighted half against the second weighted half to clamp a fishing line therebetween.

2. The detachable clamping sinker of claim 1 configured to allow the first weighted half and the second weighted half to be separated by hand by increasing tension on the elastic member to facilitate release of the fishing line.

3. The detachable clamping sinker of claim 1 wherein one of the first and second weighted halves is configured with a groove for retaining the fishing line.

4. The detachable clamping sinker of claim 1 wherein the second weighted half has greater mass than the first weighted half.

5. The detachable clamping sinker of claim 4 wherein the second weighted half comprises at least 90 percent of total mass of the sinker.

6. The detachable clamping sinker of claim 1 further comprising one or more offsets displacing the first weighted half from the second weighted half to expose the rapidly disintegrating water soluble material.

7. The detachable clamping sinker of claim 6 wherein the one or more offsets comprise one or more rails projecting from one or both of the weighted halves, the rails disposed longitudinally in the direction of the tension.

8. The detachable clamping sinker of claim 7 further comprising one or more slots disposed in one or both of the weighted halves and configured for cooperative engagement with the one or more rails.

9. The detachable clamping sinker of claim 1 wherein the first weighted half and the second weighted half comprise a fishing line locking means.

10. The detachable clamping sinker of claim 9 wherein the fishing line locking means comprises cooperatively engaging angled edges.

11. The detachable clamping sinker of claim 9 wherein the fishing line locking means comprises one or more complimentary pairs of protrusions and recesses.

12. The detachable clamping sinker of claim 9 wherein the fishing line locking means comprises a jaw formed on one of the weighted halves and upper and lower shelves bordering the jaw.

13. The detachable clamping sinker of claim 1 wherein the first weighted half comprises a stationary half that the second weighted half comprises a rotating half.

14. The detachable clamping sinker of claim 13 wherein the rotating half is rotatably coupled to the stationary half by means of a bearing integrally formed to the stationary half.

15. The detachable clamping sinker of claim 1 wherein the first weighted half comprises a stationary half and the second weighted half comprises a sliding half.

16. The detachable clamping sinker of claim 1 further comprising a channel formed in a proximal end of one of the weighted halves to externally expose the rapidly disintegrating water soluble material.

17. The detachable clamping sinker of claim 1 wherein the elastic tie assembly comprises an elastic strip connected at one end to a retaining tab and at an opposite end to a dissolvable plug.

18. The detachable clamping sinker of claim 1 wherein the elastic tie assembly comprises an elastic strip connected at one end to a retaining tab and at an opposite end to a dissolvable strip.

19. The detachable clamping sinker of claim 1 wherein the elastic tie assembly comprises an elastic band 732 coupled to one or more loops of rapidly disintegrating water soluble material.

20. The detachable clamping sinker of claim 1 wherein the first weighted half defines a slot, wherein the second weighted half comprises a rail, and wherein the rail extends into the slot to limit both transverse and longitudinal displacement of the second weighted half with respect to the first weighted half.
